(19) United States
(12) Patent Application Publication
(10) Pub. No.: US 2026/0188755 A1
(43) Pub. Date: Jul. 2, 2026

(54) SECONDARY BATTERY

(71) Applicant: MURATA MANUFACTURING CO., LTD., Kyoto (JP)

(72) Inventor: Masayuki IHARA, Kyoto (JP)

(21) Appl. No.: 19/371,290

(22) Filed: Oct. 28, 2025

(30) Foreign Application Priority Data
Dec. 27, 2024 (JP) 2024-233067

(51) Int. Cl. H01M 10/0587; H01M 4/02; H01M 4/40; H01M 10/0525; H01M 10/0567; H01M 10/0569; H01M 50/534

(52) U.S. Cl. CPC H01M 10/0587; H01M 4/405; H01M 10/0525; H01M 10/0567; H01M 10/0569; H01M 50/534; H01M 2004/028; H01M 2300/0034; H01M 2300/004

(57) ABSTRACT

A secondary battery is provided and includes a positive electrode, a negative electrode, and an electrolytic solution. The positive electrode includes a positive electrode current collector including aluminum and a positive electrode active material layer provided on the positive electrode current collector. The positive electrode active material layer includes a lithium-containing compound. The electrolytic solution includes an electrolyte, a solvent, and an additive. The electrolyte includes a bis(fluorosulfonyl)imide salt. The solvent includes at least one of an ethylene carbonate, a propylene carbonate, a fluoroethylene carbonate, a dimethyl carbonate, and a gamma butyrolactone. The additive includes at least one of a lithium fluorophosphate, a sulfinyl compound, and a dinitrile compound. The molar ratio of the original solvent to lithium ions, which is calculated from a vibration spectrum of the electrolytic solution, is more than 0 and 1.78 or less.

### CROSS REFERENCE TO RELATED APPLICATIONS

The present application claims priority to Japanese patent application no. 2024-233067, filed on Dec. 27, 2024, the entire contents of which is incorporated herein by reference.

### BACKGROUND

The present disclosure relates to a secondary battery.

A secondary battery is disclosed and including a positive electrode that has a positive electrode current collector made of aluminum and an electrolytic solution containing imide anions.

### SUMMARY

The present disclosure relates to a secondary battery.

However, the secondary battery as referenced in the Background section has the possibility of degrading the charge-discharge characteristics due to the electrolytic solution.

The present disclosure, in an embodiment, relates to providing improving charge-discharge characteristics.

A secondary battery according to an aspect of the present disclosure is a secondary battery including: a positive electrode; a negative electrode; and an electrolytic solution, in which the positive electrode includes a positive electrode current collector containing aluminum, and a positive electrode active material layer provided on the positive electrode current collector, the positive electrode active material layer contains a lithium-containing compound, the electrolytic solution contains an electrolyte, a solvent, and an additive, the electrolyte contains a bis(fluorosulfonyl)imide salt, the solvent contains at least one of the first group consisting of an ethylene carbonate, a propylene carbonate, a fluoroethylene carbonate, a dimethyl carbonate, and a gamma butyrolactone, the additive contains at least one of a lithium fluorophosphate, a sulfinyl compound, and a dinitrile compound, the lithium fluorophosphate contains at least one of a lithium monofluorophosphate (Li₂PFO₃) and a lithium difluorophosphate (LiPF₂O₂), the sulfinyl compound contains at least one of compounds represented by respective formulas (1), (2), (3), (4), (5), (6), and (7):

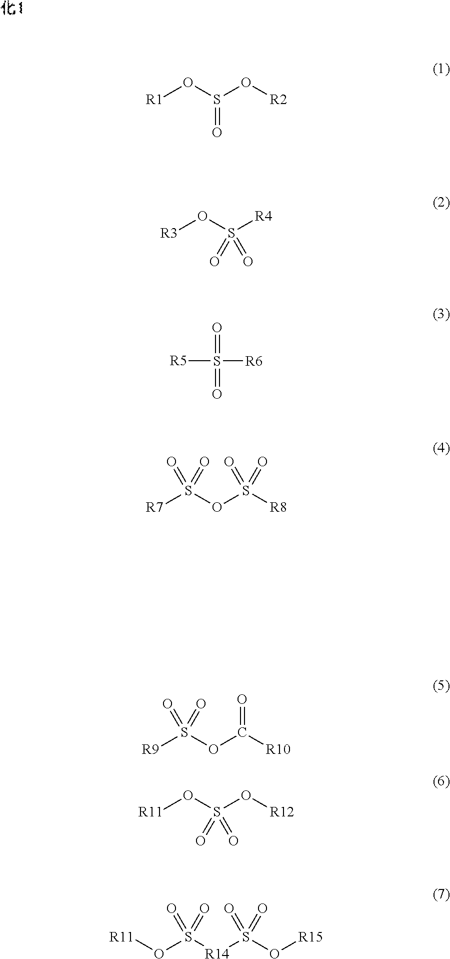

where each of R1 to R15 is any of a monovalent hydrocarbon group and a monovalent fluorinated hydrocarbon group, and R15 is any of a divalent hydrocarbon group and a divalent fluorinated hydrocarbon group, provided that R1 and R2 may be bonded to each other, R3 and R4 may be bonded to each other, R5 and R6 may be bonded to each other, R7 and R8 may be bonded to each other, R9 and R10 may be bonded to each other, R11 and R12 may be bonded to each other, and any two or more of R13 to R15 may be bonded to each other,
the dinitrile compound contains a compound represented by the formula (8):

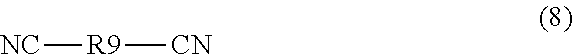

where R9 is any of an alkylene group, a phenylene group, a fluorinated alkylene group, and a fluorinated phenylene group, and
the molar ratio of the original solvent to lithium ions, which is calculated from a vibration spectrum of the electrolytic solution, is more than 0 and 1.78 or less.

The present disclosure can improve charge-discharge characteristics according to an embodiment.

### BRIEF DESCRIPTION OF THE FIGURES

FIG. 1 is a perspective view illustrating a configuration of a secondary battery according to an embodiment; and

FIG. 2 is an enlarged sectional view illustrating the configuration of the battery element illustrated in FIG. 1.

### DETAILED DESCRIPTION

The present disclosure will be described below in further detail including with reference to the drawings according to an embodiment. Note that the present disclosure is not limited thereby.

A secondary battery according to an embodiment will be described. The secondary battery according to an embodiment is a secondary battery that utilizes occlusion and release of an electrode reactant to obtain a battery capacity and includes a positive electrode, a negative electrode, and an electrolytic solution.

The type of the electrode reactant is not particularly limited, and is specifically a light metal such as an alkali metal and an alkaline earth metal. Specific examples of the alkali metal include lithium, sodium, and potassium. Specific examples of the alkaline earth metal include beryllium, magnesium, and calcium. In addition, the type of the electrode reactant may be another light metal such as aluminum.

In the following description, a case where the electrode reactant is lithium will be described as an example. A secondary battery that utilizes occlusion and release of lithium to obtain a battery capacity is, for example, a lithium ion secondary battery. In the lithium ion secondary battery, lithium is occluded and released in an ionic state.

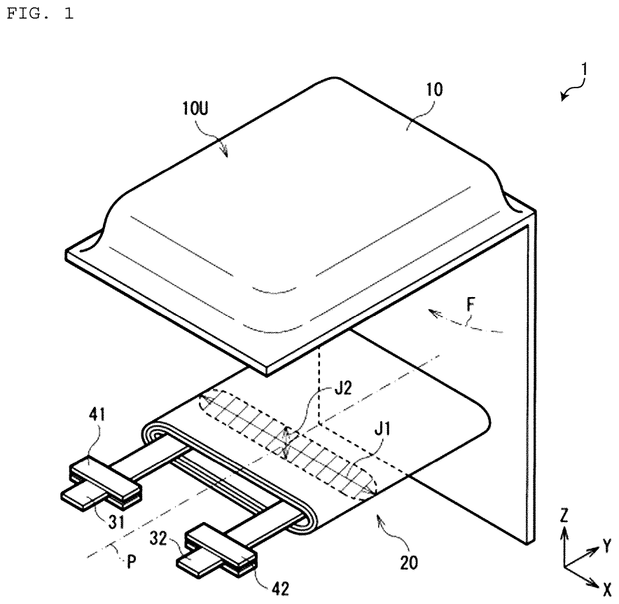

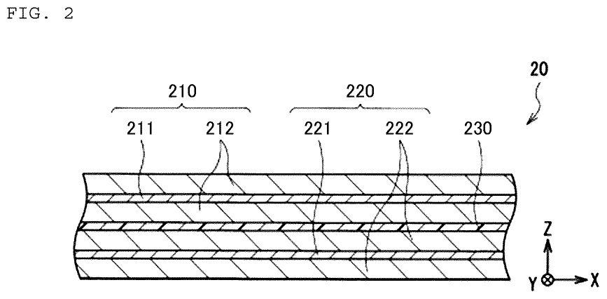

FIG. 1 is a perspective view illustrating a configuration of a secondary battery according to an embodiment. FIG. 2 is an enlarged sectional view illustrating the configuration of the battery element illustrated in FIG. 1. FIG. 1 illustrates an exterior film 10 and a battery element 20 separated from each other, and a section of the battery element 20 is indicated by a broken line. FIG. 2 illustrates a section of only a part of the battery element 20.

As illustrated in FIGS. 1 and 2, the secondary battery 1 includes the exterior film 10, the battery element 20, a positive electrode lead 31, a negative electrode lead 32, and sealing films 41 and 42.

For the secondary battery 1 according to FIG. 1, the exterior film 10 is used as an exterior member for housing the battery element 20 as mentioned above. Thus, the secondary battery 1 illustrated in FIG. 1 is a so-called laminate film type secondary battery.

As illustrated in FIG. 1, the exterior film 10 is an exterior member that houses the battery element 20, and has a sealed bag-shaped structure in which the battery element 20 is housed. Thus, the exterior film 10 houses a positive electrode 210, a negative electrode 220, a separator 230, and an electrolytic solution, not shown, which will be described later.

In the example of FIG. 1, the exterior film 10 is a single film-shaped member, and is folded in a folding direction F. The exterior film 10 is provided with a recess 10U for housing the battery element 20. The recess 10U is a so-called deep drawn part.

Specifically, the exterior film 10 is a three-layer laminate film that has a fusion layer, a metal layer, and a surface protective layer laminated in this order from the inside. With the exterior film 10 folded, mutually facing outer peripheral edges of the fusion layer are fused to each other. The fusion layer contains a polymer compound such as a polypropylene. The metal layer contains a metal material such as aluminum. The surface protective layer contains a polymer compound such as nylon. Note that the configuration (number of layers) of the exterior film 10 is not particularly limited, and may have one layer, two layers, or four or more layers.

As illustrated in FIGS. 1 and 2, the positive electrode lead 31 is a positive electrode wiring connected to a positive electrode current collector 211 of the positive electrode 210, and is extended to the outside of the exterior film 10. The positive electrode lead 31 contains at least one or more conductive materials such as metal materials, and specific examples of the conductive materials include aluminum. Further, the shape of the positive electrode lead 31 is not particularly limited, and is, for example, a thin plate shape, a mesh shape, or the like.

As illustrated in FIGS. 1 and 2, the negative electrode lead 32 is a negative electrode wiring connected to a negative electrode current collector 221 of the negative electrode 220, and is extended to the outside of the exterior film 10. The negative electrode lead 32 contains at least one or more conductive materials such as metal materials. Specific examples of the conductive materials include copper. Further, the shape of the negative electrode lead 32 is not particularly limited, and is, for example, a thin plate shape, a mesh shape, or the like.

As illustrated in FIG. 1, the sealing film 41 is inserted between the exterior film 10 and the positive electrode lead 31. In addition, as illustrated in FIG. 1, the sealing film 42 is inserted between the exterior film 10 and the negative electrode lead 32. However, one or both of the sealing films 41 and 42 may be omitted.

The sealing film 41 is a sealing member that prevents entry of outside air and the like into the exterior film 10. The sealing film 41 contains a polymer compound such as a polyolefin that has close contact with the positive electrode lead 31. Specific examples of the polymer compound include a polypropylene.

The sealing film 42 is a sealing member that prevents entry of outside air and the like into the exterior film 10. The sealing film 42 contains a polymer compound such as a polyolefin that has close contact with the negative electrode lead 32. Specific examples of the polymer compound include a polypropylene.

The battery element 20 is housed in the space of the recess 10U of the exterior film 10. The battery element 20 is a so-called power generation element. As illustrated in FIGS. 1 and 2, the battery element 20 includes the positive electrode 210, the negative electrode 220, the separator 230, and an electrolytic solution, not shown.

In the example of FIG. 1, the battery element 20 is a so-called wound electrode body. Thus, the positive electrode 210 and the negative electrode 220 are wound around a winding axis P while facing each other with the separator 230 interposed therebetween. In the following description, a direction along the winding axis P may be referred to as a Y direction, and a longer direction of the battery element 20, of direction perpendicular to the winding axis P, may be referred to as an X direction, whereas a shorter direction of the battery element 20, of the directions perpendicular to the winding axis P, may be referred to as a Z direction.

In the example of FIG. 1, the battery element 20 has a flattened three-dimensional shape. More specifically, the shape of a section (a section along the XZ plane) of the battery element 20, intersecting with the winding axis P of the battery element 20, is a flattened shape defined by a major axis J1 and a minor axis J2. The major axis J1 is an imaginary axis extending in the X-axis direction, and has a length larger than the length of the minor axis J2. The minor axis J2 is an imaginary axis extending in the Z-axis direction, and has a length smaller than the length of the major axis J1. Thus, the sectional shape of the battery element 20 is a flattened substantially elliptical shape. Note that the three-dimensional shape of the battery element 20 is an example, and is not limited to the above-mentioned shape.

The positive electrode 210 includes the positive electrode current collector 211 and positive electrode active material layers 212. In the positive electrode 210, the positive electrode current collector 211 is laminated between the positive electrode active material layers 212. However, the positive electrode active material layer 212 may be provided only on one surface of the positive electrode current collector 211 on the side where the positive electrode 210 faces the negative electrode 220.

The positive electrode current collector 211 contains aluminum, and for example, an aluminum foil can be used. The surface state of the positive electrode current collector 211 will be described later.

The positive electrode active material layer 212 is a layer containing a positive electrode active material capable of occluding and releasing lithium. The positive electrode active material layer 212 contains a positive electrode active material. The positive electrode active material layer 212 is not limited to the materials cited above, and may further contain, for example, a binder, a conductive agent, and a dispersant.

The positive electrode active material is preferably a lithium-containing compound such as a lithium-containing composite oxide and a lithium-containing phosphate compound. The lithium-containing composite oxide is an oxide containing lithium and one or more elements other than lithium as constituent elements. The lithium-containing composite oxide has, for example, a layered rock-salt-type or spinel-type crystal structure. The lithium-containing phosphate compound is a phosphate compound containing lithium and one or more elements other than lithium as constituent elements. The lithium-containing phosphate compound has, for example, an olivine-type crystal structure. Specific examples of the lithium-containing composite oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15} (Mn_{0.65}Ni_{0.22}Co_{0.13})O₂, and LiMn₂O₄. Specific examples of the lithium-containing phosphate compound include LiFePO₄, LiMnPO₄, LiFe_{0.5}Mn_{0.5}PO₄, and LiFe_{0.3}Mn_{0.7}PO₄. In this regard, the presence of the lithium-containing composite oxide or the lithium-containing phosphate compound can be analyzed with the use of various elemental analysis methods. The elemental analysis method includes any one of or two or more of analysis methods such as X-ray diffraction (XRD), high-frequency inductively coupled plasma (ICP) emission spectroscopy, and energy dispersive X-ray spectroscopy (EDX).

The positive electrode active material is more preferably at least one of a first lithium composite oxide and a second lithium composite oxide. The first lithium composite oxide is a lithium-containing compound represented by the formula (9):

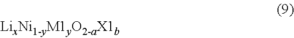

where M1 is at least one of Co, Mn, Mg, Ba, Al, B, Ti, V, Cr, Fe, Cu, Zn, Zr, Mo, Sn, Ca, Sr, W, Na, K, Nb, Ta, and a rare earth element. X1 is at least one of F, Cl, Cr, I, P, S, and Si, and x, y, a, and b satisfy 0.9≤x≤1.1, 0.005≤y≤0.5, −0.1≤a≤0.2, and 0≤b≤0.1.

The second lithium composite oxide is a lithium-containing compound represented by the formula (10):

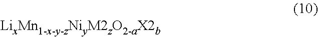

where M2 is at least one of Co, Mg, Ba, Al, B, Ti, V, Cr, Fe, Cu, Zn, Zr, Mo, Sn, Ca, Sr, W, Na, K, Nb, Ta, and a rare earth element. X2 is at least one of F, Cl, Cr, I, P, S, and Si, and x, y, z, a, and b satisfy 0<x≤0.3, 0.3≤y≤0.9, 0≤z≤0.5, −0.1≤a≤0.2, and 0≤b≤0.1.

In the present disclosure, the rare earth element refers to Sc, Y, and lanthanoid.

The binder (positive electrode binder) contained in the positive electrode active material layer 212, which may be an arbitrary material, contains, for example, one or more of synthetic rubbers and polymer compounds. Examples of the synthetic rubbers include a styrene-butadiene-based rubber, a fluorine-based rubber, and ethylene propylene diene. Examples of the polymer compounds include a polyvinylidene fluoride (PVdF) and a polyimide.

The conductive agent (positive electrode conductive agent) contained in the positive electrode active material layer 212, which may be an arbitrary material, contains, for example, carbon. Examples of the carbon include graphite, carbon black, acetylene black, and ketjen black. The conductive agent contained in the positive electrode active material layer 212 is, however, not limited to these examples as long as the conductive agent is a material with conductivity, and may be a metal material, a conductive polymer, or the like.

The negative electrode 220 includes the negative electrode current collector 221 and negative electrode active material layers 222. In the negative electrode 220, the negative electrode current collector 221 is laminated between the negative electrode active material layers 222. However, the negative electrode active material layer 222 may be provided only on one surface of the negative electrode current collector 221 on the side where the negative electrode 220 faces the positive electrode 210.

The negative electrode current collector 221 is a conductor, and for example, a copper foil or the like can be used.

The negative electrode active material layer 222 is a layer containing a negative electrode active material capable of occluding and releasing lithium. The negative electrode active material layer 222 is not limited to being made of only the negative electrode active material, and may contain, for example, a conductive agent and a binder.

The negative electrode active material preferably contains at least one of a carbon material and a metal-based material. Thus, a high energy density is achieved. Specific examples of the carbon material for use as the negative electrode active material include graphitizable carbon, non-graphitizable carbon, natural graphite, and artificial graphite. The metal-based material for use as the negative electrode active material is a material containing any one or more of metal elements and metalloid elements capable of forming alloys with lithium as constituent elements. Specific examples of the metal elements and the metalloid elements for use as the negative electrode active material include silicon and tin. The metal-based material for use as the negative electrode active material may be a simple substance, an alloy, a compound, a mixture of two or more materials, or a material including two or more phases. Specific examples of the metal-based material for use as the negative electrode active material include TiSi₂ and SiOₓ (0<x≤2).

Further, the negative electrode active material layer 222 is not limited to containing only the negative electrode active material.

For example, the negative electrode active material layer 222 may further contain a negative electrode binder. The negative electrode binder contains at least one of synthetic rubbers, polymer compounds, and the like. Specific examples of the synthetic rubbers for use as the negative electrode binder include a styrene-butadiene-based rubber, fluorine-based rubber, and ethylene propylene diene. Specific examples of the polymer compounds for use as the negative electrode binder include a polyvinylidene fluoride, a polyimide, and a carboxymethyl cellulose.

For example, the negative electrode active material layer 222 may further contain a negative electrode conductive agent. The negative electrode conductive agent contains at least one of a carbon material, a metal material, and a conductive polymer compound. Specific examples of the carbon material for use as the negative electrode conductive agent include particulate carbon materials such as carbon black, acetylene black, and ketjen black, and fibrous carbon materials such as carbon nanotubes. The carbon nanotube is, for example, a single wall carbon nanotube (SWCNT). Thus, the electron conductivity of the particle surface of the negative electrode active material can be improved. The mass ratio of the negative electrode conductive agent to the negative electrode active material layer 222 is preferably 5% or less, more preferably 2% or less. Thus, the paintability of a negative electrode slurry can be improved.

The separator 230 is a membrane that insulates the positive electrode 210 from the negative electrode 220. The separator 230 is provided between a main surface of the positive electrode 210 and a main surface of the negative electrode 220 so as to keep the positive electrode 210 and the negative electrode 220 from coming into direct contact with each other.

Preferably, the material of the separator 230 is electrically stable, is chemically stable against the positive electrode active material, the negative electrode active material, and the electrolytic solution, and has an insulating property. For the separator 230, a layer made of a polymer nonwoven fabric, a porous film, glass, or ceramic fibers can be used, for example. The material of the separator 230 more preferably includes a porous polyolefin film. Thus, the safety of the battery can be improved by the effect of short circuit prevention and the effect of shutdown.

Each of the positive electrode 210, the negative electrode 220, and the separator 230 is impregnated with the electrolytic solution. In the example of FIG. 1, the space inside the exterior film 10 is filled with the electrolytic solution. The electrolytic solution is a non-aqueous electrolytic solution containing an electrolyte salt, a non-aqueous solvent in which the electrolyte salt is dissolved, and an additive.

The electrolyte salt contains a salt of a bis(fluorosulfonyl)imide such as a lithium bis(fluorosulfonyl)imide (LiFSI, LiN(SO₂F₂)₂). Thus, the charge-discharge characteristics can be improved. Further, the electrolyte salt may contain another electrolyte salt for use as an electrolyte salt of a lithium ion battery. For example, the other electrolyte salt is a light metal salt such as a lithium salt. Specific examples of the lithium salt are preferably lithium salts containing phosphorus (P) such as a lithium hexafluorophosphate (LiPF₆), a lithium monofluorophosphate (Li₂PFO₃), and a lithium difluorophosphate (LiPF₂O₂), and lithium salts containing boron (B) such as a lithium tetrafluoroborate (LiBF₄), and a lithium bis(oxalato) borate (LiB(C₂O₄)₂). Thus, P or B can be contained in the surface of the positive electrode current collector 211. Further, the other electrolyte salt is not limited to the above-mentioned examples, and may be a lithium trifluoromethanesulfonate (LiCF₃SO₃), a lithium bis(trifluoromethanesulfonyl)imide (LiN(CF₃SO₂)₂), a lithium tris(trifluoromethanesulfonyl) methide (LiC(CF₃SO₂)₃), or the like.

The solvent contains at least one selected from the first group consisting of an ethylene carbonate (EC), a propylene carbonate (PC), a fluoroethylene carbonate (FEC), a dimethyl carbonate (DMC), and a gamma butyrolactone (GBL).

The solvent may further contain at least one of carbonic acid esters excluding the compounds included in the first group and chain carboxylic acid esters. Examples of the carbonic acid esters excluding the compounds included in the first group include a diethyl carbonate (DEC) and an ethyl methyl carbonate (EMC). Examples of the chain carboxylic acid esters include a propyl propionate (PrPr), an ethyl propionate (PrEt), a methyl propionate, a propyl acetate (AcPr), an ethyl acetate (AcEt), and a methyl acetate (AcMe).

The solvent may further contain another non-aqueous solvent for use as a non-aqueous solvent of a lithium ion battery. Examples of the other non-aqueous solvent include ethers such as 1,2-dimethoxyethane, tetrahydrofuran, 1,3-dioxolane, and 1,4-dioxane. The ethers may be compounds in which some or all of hydrogen atoms are substituted with fluorine, such as 1,1,2-tetrafluoroethyl 2,2,2,3,3-tetrafluoropropyl ether.

The additive contains at least one of a lithium fluorophosphate, a sulfinyl compound, and a dinitrile compound.

The lithium fluorophosphate is a compound (lithium salt that has a specific composition) containing lithium (Li), phosphorus (P), fluorine (F), and oxygen (O) as constituent elements, and more specifically, contains at least one of a lithium monofluorophosphate (Li₂PFO₃) and a lithium difluorophosphate (LiPF₂O₂). The electrolytic solution contains the lithium fluorophosphate, thereby allowing the decomposition reaction of the electrolytic solution to be inhibited while ion conductivity is ensured. In particular, also when the secondary battery in which the electrolytic solution is used is used (charged and discharged) and stored in a high-temperature environment, the decomposition reaction of the electrolytic solution can be effectively inhibited.

The content ratio of the lithium fluorophosphate in the electrolytic solution is not particularly limited, and can be arbitrarily set. Above all, the content ratio of lithium fluorophosphate is preferably 0.058 by mass or more and 3% by mass or less. Thus, the decomposition reaction of the electrolytic solution can be sufficiently inhibited while ion conductivity is ensured.

The sulfinyl compound contains at least one of compounds represented by respective formulas (1), (2), (3), (4), (5), (6), and (7):

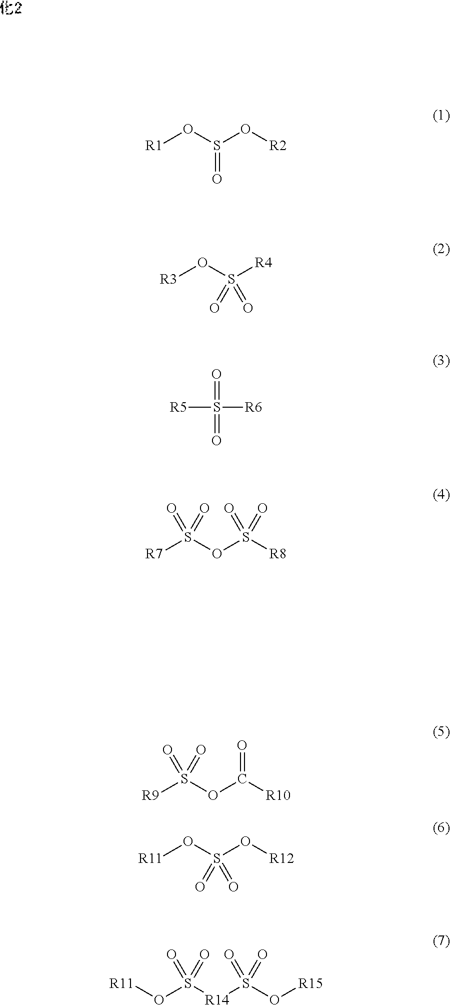

where each of R1 to R15 is any of a monovalent hydrocarbon group and a monovalent fluorinated hydrocarbon group, and R15 is any of a divalent hydrocarbon group and a divalent fluorinated hydrocarbon group, provided that R1 and R2 may be bonded to each other, R3 and R4 may be bonded to each other, R5 and R6 may be bonded to each other, R7 and R8 may be bonded to each other, R9 and R10 may be bonded to each other, R11 and R12 may be bonded to each other, and any two or more of R13 to R15 may be bonded to each other.

The electrolytic solution contains the sulfinyl compound, thereby allowing the decomposition reaction of the electrolytic solution to be inhibited while ion conductivity is ensured. In particular, also when the secondary battery in which the electrolytic solution is used is used (charged and discharged) and stored in a high-temperature environment, the decomposition reaction of the electrolytic solution can be effectively inhibited.

The monovalent hydrocarbon group is a general term for monovalent groups composed of carbon and hydrogen, and may be linear or branched with at least one side chain. This monovalent hydrocarbon group may include a carbon-carbon unsaturated bond or may include no carbon-carbon unsaturated bond. In this regard, the carbon-carbon unsaturated bond is, for example, at least one of a carbon-carbon double bond and a carbon-carbon triple bond. Specific examples of the monovalent hydrocarbon group include, an alkyl group, an alkenyl group, an alkynyl group, an aryl group, and a cycloalkyl group. Specific examples of the alkyl group include a methyl group (—CH₃), an ethyl group (—C₂H₅), and a propyl group (—C₃H₇). Specific examples of the alkenyl group include a vinyl group (—CH═CH₂) and an allyl group (—CH₂—CH═CH₂). Specific examples of the alkynyl group include an ethynyl group (—C═CH). Specific examples of the aryl group include a phenyl group and a naphthyl group. Specific examples of the cycloalkyl group include a cyclopropyl group, a cyclobutyl group, a cyclopentyl group, a cyclohexyl group, a cycloheptyl group, and a cyclooctyl group. The number of carbon atoms of the alkyl group is not particularly limited but, among others, is preferably 1 or more and 12 or less. The number of carbon atoms for each of the alkenyl group and the alkynyl group is not particularly limited but, among others, is preferably 2 or more and 12 or less. The number of carbon atoms of the aryl group is not particularly limited but, among others, is preferably 6 or more and 18 or less. The number of carbon atoms of the cycloalkyl group is not particularly limited but, among others, is preferably 3 or more and 18 or less. These are because the solubility and compatibility of the sulfinyl compound are improved in each of the cases.

The monovalent fluorinated hydrocarbon group is a compound in which at least one hydrogen atom of the monovalent hydrocarbon group mentioned above is substituted with a fluorine atom. Specific examples of the monovalent fluorinated hydrocarbon group include a perfluoromethyl group (—CF₃) and a perfluoroethyl group (—C₂F₅), which are compounds in which at least one hydrogen atom of an alkyl group is substituted with fluorine.

The divalent hydrocarbon group is a general term for divalent groups composed of carbon and hydrogen, and may be linear or branched with at least one side chain. This divalent hydrocarbon group may include a carbon-carbon unsaturated bond or may include no carbon-carbon unsaturated bond. Specific examples of the divalent hydrocarbon group include an alkylene group, an alkenylene group, an alkynylene group, an arylene group, and a cycloalkylene group. Specific examples of the alkylene group include a methylene group (—CH₂—), an ethylene group (—C₂H₄—), and a propylene group (—C₃H₆—). Specific examples of the alkenylene group include a vinylene group (—CH═CH—) and an arylene group (—CH₂—CH═CH—). Specific examples of the alkynylene group include an ethynylene group (—C═C—). Specific examples of the arylene group include a phenylene group and a naphthylene group. Specific examples of the cycloalkylene group include a cyclopropylene group, a cyclobutylene group, a cyclopentylene group, a cyclohexylene group, a cycloheptylene group, and a cyclooctylene group. The number of carbon atoms of the alkylene group is not particularly limited but, among others, is preferably 1 or more and 12 or less. The number of carbon atoms for each of the alkenylene group and the alkynylene group is not particularly limited but, among others, is preferably 2 or more and 12 or less. The number of carbon atoms of the arylene group is not particularly limited but, among others, is preferably 6 or more and 18 or less. The number of carbon atoms of the cycloalkylene group is not particularly limited but, among others, is preferably 3 or more and 18 or less. These are because the solubility and compatibility of the sulfinyl compound are improved in each of the cases.

The divalent fluorinated hydrocarbon group is a compound in which at least one hydrogen atom of the divalent hydrocarbon group mentioned above is substituted with a fluorine atom. Specific examples of the divalent fluorinated hydrocarbon group include a perfluoromethylene group (—CF₂—) and a perfluoroethylene group (—C₂F₄—), which are compounds in which at least one hydrogen atom of an alkylene group is substituted with fluorine.

While R1 and R2 are not bonded to each other in formula (1), the sulfinyl compound is not limited thereto, and R1 and R2 may be bonded to each other. While R3 and R4 are not bonded to each other in formula (2), the sulfinyl compound is not limited thereto, and R3 and R4 may be bonded to each other. While R5 and R6 are not bonded to each other in formula (3), the sulfinyl compound is not limited thereto, and R5 and R6 may be bonded to each other. While R7 and R8 are not bonded to each other in formula (4), the sulfinyl compound is not limited thereto, and R7 and R8 may be bonded to each other. While R9 and R10 are not bonded to each other in formula (5), the sulfinyl compound is not limited thereto, and R9 and R10 may be bonded to each other. While R11 and R12 are not bonded to each other in formula (6), the sulfinyl compound is not limited thereto, and R11 and R12 may be bonded to each other. While R13 to R15 are not bonded to each other in formula (7), the sulfinyl compound is not limited thereto, and two or more of R13 to R15 may be bonded to each other. In other words, the sulfinyl compound represented by each of the formulas (1) to (7) may be a cyclic compound including carbon and hydrogen.

Specific examples of the compound represented by the formula (1) include compounds represented by the following respective formulas (1-1) to (1-10). Specific examples of the compound represented by the formula (2) include compounds represented by the following respective formulas (2-1) to (2-6). Specific examples of the compound represented by the formula (3) include compounds represented by the following respective formulas (3-1) to (3-5). Specific examples of the compound represented by the formula (4) include compounds represented by the following respective formulas (4-1) to (4-17). Specific examples of the compound represented by the formula (5) include compounds represented by the following respective formulas (5-1) to (5-18). Specific examples of the compound represented by the formula (6) include compounds represented by the following respective formulas (6-1) to (6-9). Specific examples of the compound represented by the formula (7) include compounds represented by the following respective formulas (7-1) to (7-14).

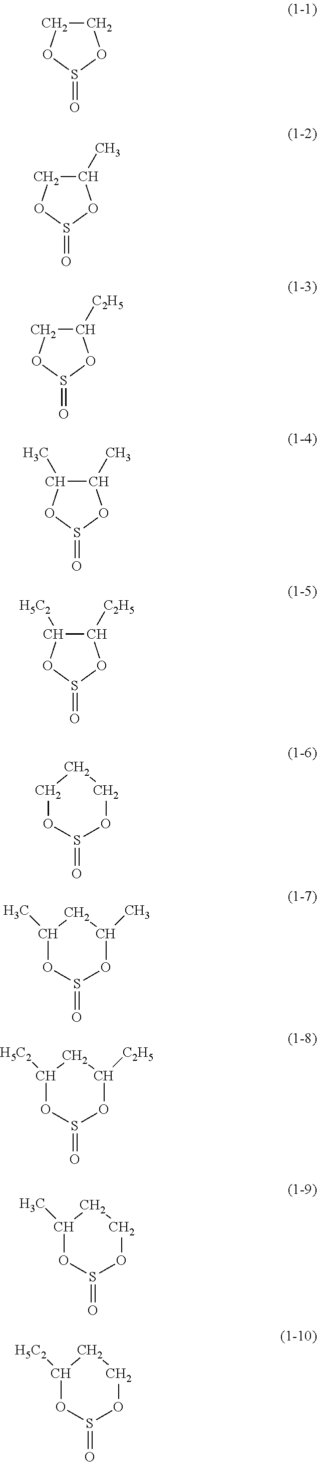

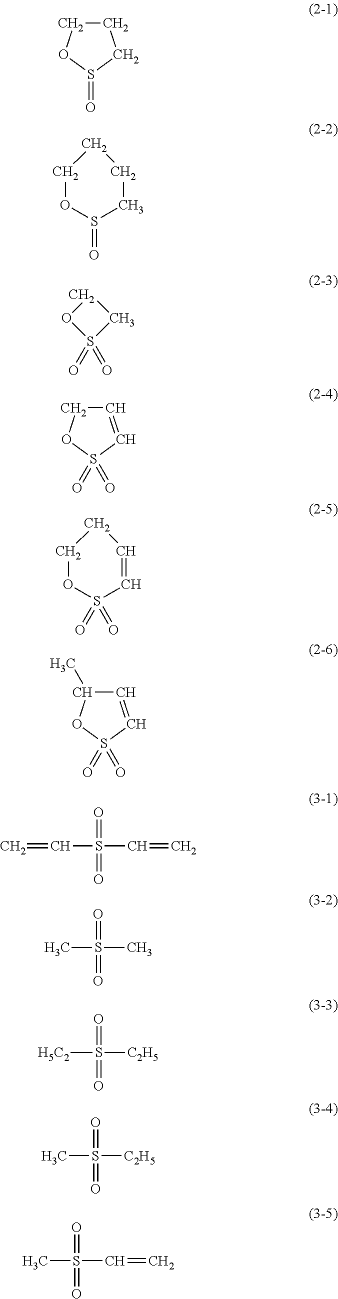

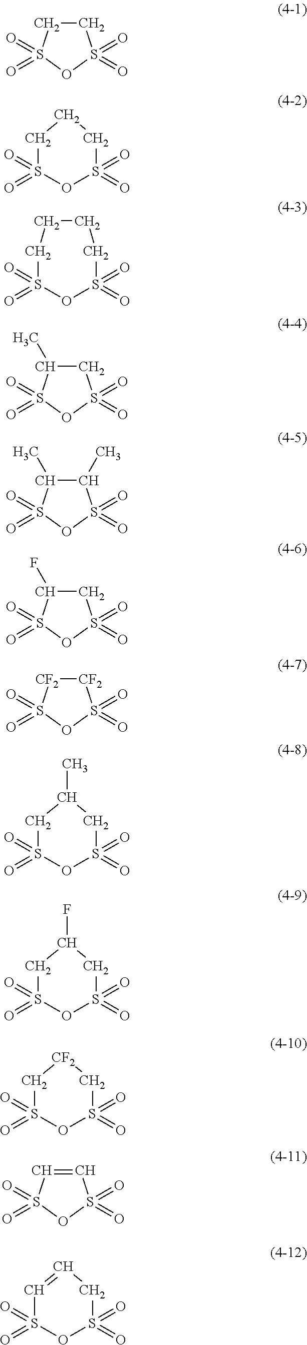

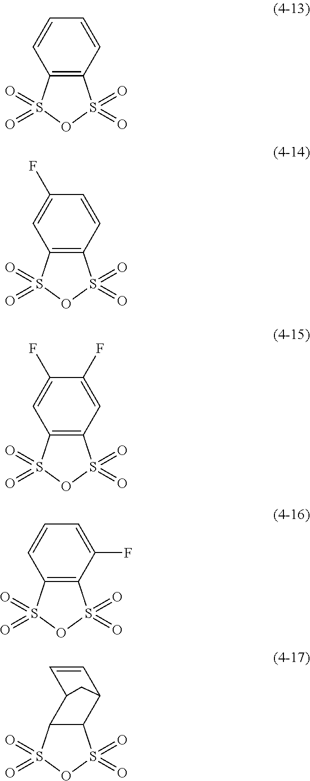

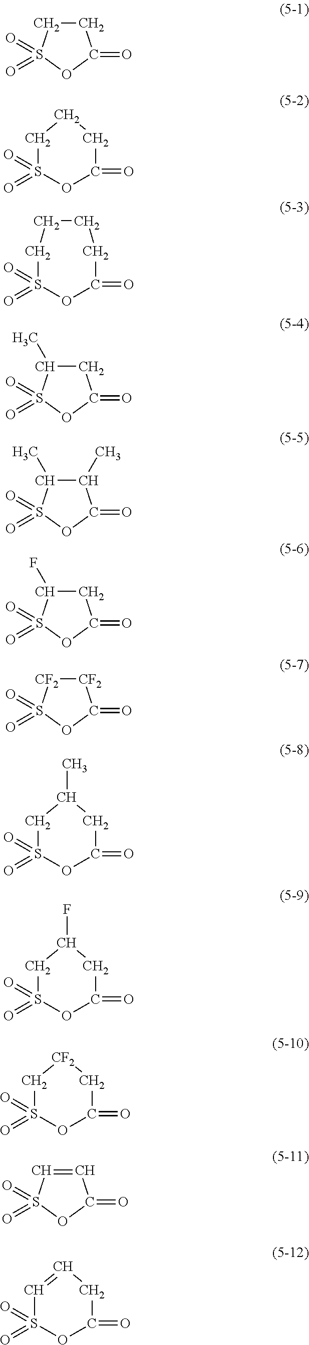

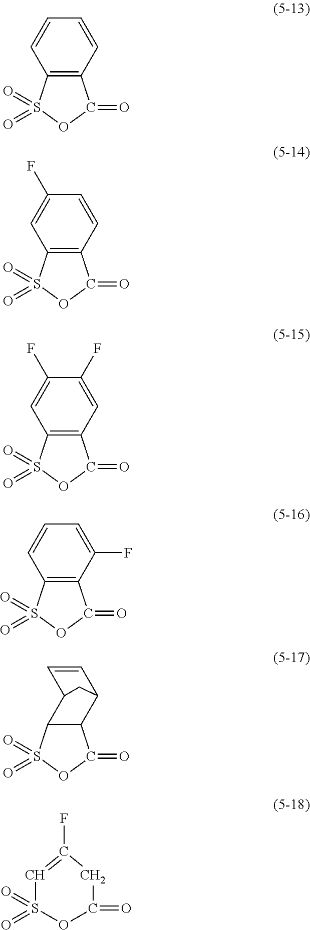

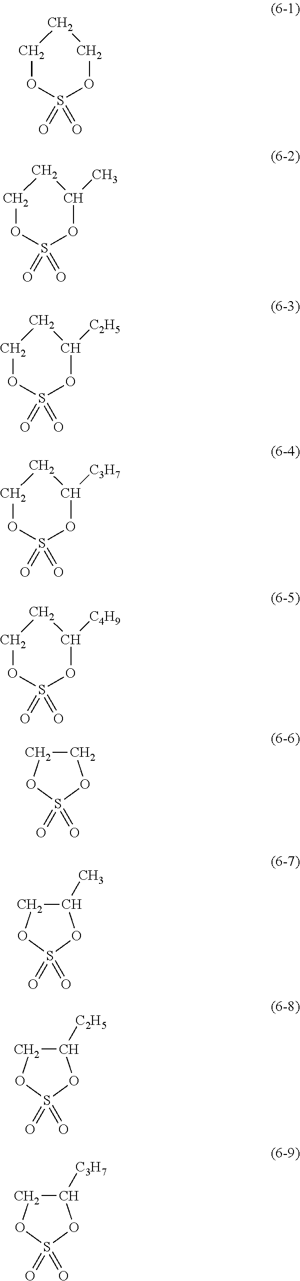

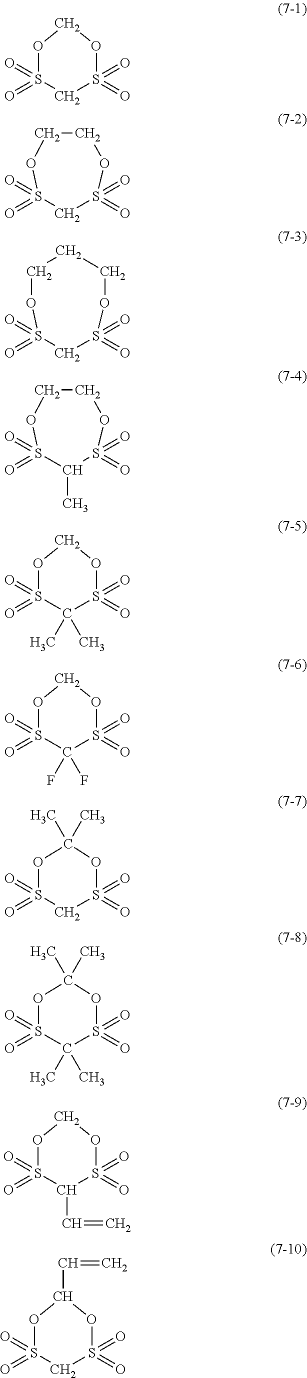

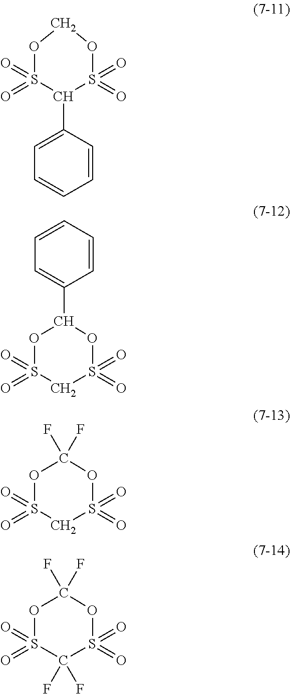

The content ratio of the sulfinyl compound in the electrolytic solution is not particularly limited, and can be arbitrarily set. Above all, the content ratio of the sulfinyl compound is preferably 0.18 by mass or more and 5% by mass or less. Thus, the decomposition reaction of the electrolytic solution can be sufficiently inhibited while ion conductivity is ensured.

The dinitrile compound is a compound including two cyano groups (—CN), and contains a compound represented by the formula (8):

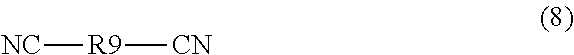

where R9 is any of an alkylene group, a phenylene group, a fluorinated alkylene group, and a fluorinated phenylene group.

The electrolytic solution contains the dinitrile compound, thereby allowing the decomposition reaction of the electrolytic solution to be inhibited while ion conductivity is ensured. In particular, also when the secondary battery in which the electrolytic solution is used is used (charged and discharged) and stored in a high-temperature environment, the decomposition reaction of the electrolytic solution can be effectively inhibited.

The details of each of the alkylene group and the phenylene group are as mentioned above.

The fluorinated alkylene group is a group in which at least one hydrogen atom of an alkylene group is substituted with a fluorine atom. The fluorinated alkylene group may be, however, linear or branched with one or two or more side chains. The number of carbon atoms of the fluorinated alkylene group is not particularly limited, but is specifically 1 or more and 10 or less. Thus, the solubility and ionizability of the electrolyte salt containing the third imide anion can be improved. Specific examples of the fluorinated alkylene group include a perfluoromethylene group (—CF₂—) and a perfluoroethylene group (—C₂F₄—).

The fluorinated phenylene group is a group in which at least one hydrogen atom of a phenylene group (—C₆H₄—) is substituted with a fluorine atom. Specific examples of the fluorinated phenylene group include a monofluorophenylene group (—C₆H₃F—).

Above all, R9 is preferably an alkylene group, and the number of carbon atoms of the alkylene group is more preferably 1 or more and 12 or less. Thus, the solubility, compatibility, and the like of the dinitrile compound can be improved.

Specific examples of the dinitrile compound include dicyanomethane (malononitrile), 1,2-dicyanoethane (succinonitrile, SN), 1,3-dicyanopropane (glutaronitrile), 1,4-dicyanobutane (adiponitrile, ADN), 1,5-dicyanopentane (pimelonitrile), 1,6-dicyanohexane (suberonitrile), 1,7-dicyanoheptane, 1,8-dicyanooctane (sebaconitrile), 1,9-dicyanononane (undecane dinitrile), 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 1,4-dicyanopentane, 2,5-dimethyl-2,5-hexanedicarbonitrile, 2,6-dicyanoheptane, 2,7-dicyanooctane, 2,8-dicyanononane, 1,6-dicyanodecane, 1,2-dicyanobenzene (phthalonitrile), 1,3-dicyanobenzene (isophthalonitrile), and 1,4-dicyanobenzene (terephthalonitrile). Note that specific example of the dinitrile compound may be compounds in which at least one hydrogen atom of the series of compounds mentioned above is substituted with a fluorine atom.

The content ratio of the dinitrile compound in the electrolytic solution is not particularly limited, and can be thus arbitrarily set. Above all, the content ratio of the dinitrile compound is preferably 0.1% by mass or more and 5% by mass or less. Thus, the decomposition reaction of the electrolytic solution can be sufficiently inhibited while ion conductivity is ensured.

The electrolytic solution may further contain, as an additive, at least one of an unsaturated cyclic carbonic acid ester, a fluorinated cyclic carbonic acid ester, a dicarboxylic acid anhydride, a disulfonic acid anhydride, a sulfuric acid ester, a nitrile compound, and an isocyanate compound. Specific examples of the unsaturated cyclic carbonic acid ester include a vinylene carbonate (VC), a methylene ethylene carbonate (MEC), and a vinyl ethylene carbonate (VEC). Specific examples of the fluorinated cyclic carbonic acid ester include a monofluoro ethylene carbonate (FEC) and a difluoro ethylene carbonate (DFEC). Specific examples of the sulfonic acid ester include a propane sultone (PS) and propene sultone (PRS). Specific examples of the dicarboxylic acid anhydride include a succinic acid anhydride (SA) and a 1,2-ethanedisulfonic acid anhydride. Specific examples of the disulfonic acid anhydride include a cyclodisone (CD) and a 2-sulfobenzoic acid anhydride. Specific examples of the sulfuric acid ester include an ethylene sulfate (DTD) and a propanedisulfonic acid anhydride (PSAH). Specific examples of the nitrile compound include a succinonitrile (SN). Specific examples of the isocyanate compound include a hexamethylene diisocyanate (HMI).

In addition, the electrolytic solution may further contain at least one of a lithium hexafluorophosphate (LiPF₆), a lithium tetrafluoroborate (LiBF₄), a lithium bis(oxalato) borate (LiBOB), and a lithium difluorophosphate (LiPF₂O₂) as an additive.

The molar ratio of the original solvent to lithium ions, which is calculated from a vibration spectrum of the electrolytic solution, is more than 0 and 1.78 or less. The molar ratio of the original solvent to lithium ions is preferably 0.10 or more. Thus, the charge-discharge characteristics can be improved. In the present disclosure, the original solvent refers to solvent molecules that are not solvated with lithium ions among solvent molecules included in the electrolytic solution. The molar ratio of the original solvent to the lithium ions according to the present disclosure can be calculated by dividing the amount of substance M₀ of the original solvent, obtained by the following formula (1), by the amount of substance of the lithium ions included in the electrolytic solution. When the electrolytic solution contains multiple types of solvents, the amount of substance M₀ of the original solvent is calculated by the following formula (1) for each type of the solvents, and the weighted average weighted with the molar ratios of the multiple types of solvents is calculated, and divided by the amount of substance of the lithium ions included in the electrolytic solution, thereby allowing the calculation of the amount of substance of the original solvent for use in the calculation of the molar ratio of the original solvent to the lithium ions.

$${M}_{0} = {M}_{all} - {M}_{N} = {M}_{all} - {c}_{t} / \{ 1 + Γ ( {I}_{o} / {I}_{s} ) \} \qquad ( 1 )$$

In the formula (1), Mₐ₁₁ represents the total amount of substance of the solvent included in the solution, MN represents the amount of substance of solvent molecules solvated with the lithium ions, cₜ represents the concentration of the solvent, Γ represents the intensity ratio of the vibration spectrum per unit concentration, Iₒ represents the peak intensity of the original solvent, and Iₛ represents the peak intensity of the solvent of the solvate. In this regard, when cₒ and cₛ are respectively the concentration of a solvent that is not solvated with the lithium ions and the concentration of the solvent solvated with the lithium ions, intensity ratio Γ of the vibration spectrum per unit concentration can be determined by the slope of a graph where cₛ/cₒ and Iₛ/Iₒ are plotted respectively on the horizontal axis and on the vertical axis.

In the present disclosure, “the peak of the original solvent” means a peak observed at a peak position (wavenumber) when a solvent that is not solvated with the lithium ions is subjected to vibration spectrometry, that is, when only the solvent is subjected to vibration spectrometry. In addition, “the peak of the solvent of the solvate” refers to a peak position when the solvent solvated with lithium ions is subjected to vibration spectrometry. In this regard, the peak of the solvent of the solvate can be distinguished from the peak of the original solvent, because the vibration spectrum is shifted with respect to the peak of the original solvent. Accordingly, the heights from the base lines to the peak tops for the peak of the original solvent and the peak of the solvent of the solvate can be defined as the peak intensities Iₒ and Iₛ, respectively. Further, when the vibration spectrum of the electrolytic solution has multiple peaks for each of the original solvent and the solvent of the solvate, the ratio of the peak intensity Iₛ to the peak intensity Iₒ may be calculated, based on peaks from which the ratio of the peak intensity Iₛ to the peak intensity Iₒ is easily determined. In addition, when the peak of the solvent of the solvate has a small shift with respect to the peak of the original solvent, thereby causing the peak of the original solvent and the peak of the solvent of the solvate to overlap to form a gentle peak, the ratio of the peak intensity Iₛ to the peak intensity Iₒ may be calculated by performing peak separation with the use of a known means.

Table 1 is a table showing examples of: the wavenumber of the peak of the original solvent; and the wavenumber of the peak of the solvent of the solvate, in the vibration spectrum of the electrolytic solution according to the present disclosure. The wavenumber of the original peak of the solvent and the wavenumber of the peak of the solvent of the solvate, shown in Table 1, can be used respectively for the measurement of Iₒ and Iₛ. As shown in Table 1, the peaks of FEC may mutually overlap with the peaks of EC and DMC, because of the peaks of FEC in the vicinity of the peaks of EC and DMC. FEC can be assumed to have the same intensity ratio Γ of the vibration spectrum per unit concentration as EC and DMC, and thus, when the solvent contains: at least one of EC and DMC; and FEC, the amount of substance of the original solvent may be calculated with a composition in which FEC is replaced with the same amount of substance of EC. Note that the values shown in Table 1 are merely examples, and the wavenumbers of peaks observed may be different from the wavenumbers shown in Table 1, depending on the measurement apparatus, measurement environment, and measurement conditions for the vibration spectrum.

TABLE 1

| | Wavenumber of Peak of | Wavenumber of Peak of |
|---|---|---|
| Solvent | Original Solvent (cm⁻¹) | Solvent of Solvate (cm-⁻¹) |
| EC | 892 | 904 |
| PC | 710 | 720 |
| FEC | 905 | 920 |
| DMC | 914 | 930 |
| GBL | 677 | 691 |

In the present disclosure, the vibration spectrum of the electrolytic solution is measured by Raman spectroscopy or Fourier transform infrared spectroscopy with the use of, as a sample, the electrolytic solution extracted by use of a centrifugal separator from the notched secondary battery to be subjected to the measurement. The measurement of the vibration spectrum of the electrolytic solution is preferably performed in an environment where the influence of moisture in the atmosphere can be reduced or ignored. The measurement of the vibration spectrum of the electrolytic solution is performed, as an example, under a condition with low humidity or no humidity, such as a dry room or a glove box, or with the use of the electrolytic solution enclosed in a transparent sealed container as a sample. Further, the electrolytic solution extracted from the secondary battery to be subjected to the measurement may be quantitatively analyzed by ICP (Inductively Coupled Plasma), NMR (Nuclear Magnetic Resonance), or GC-MS (Gas Chromatography Mass Spectrometry); based on the obtained composition of the electrolytic solution, an electrolytic solution may be prepared so as to have the same composition as the electrolytic solution of the secondary battery to be subjected to the measurement; and the prepared electrolytic solution may be used as a sample for the vibration spectrum measurement.

As described above, the secondary battery 1 according to a first embodiment is a secondary battery including the positive electrode 210, the negative electrode 220, and the electrolytic solution. The positive electrode 210 includes the positive electrode current collector 211 containing aluminum and the positive electrode active material layer 212 provided on the positive electrode current collector 211. The positive electrode active material layer 212 contains a lithium-containing compound. The electrolytic solution contains an electrolyte, a solvent, and an additive. The electrolyte contains a bis(fluorosulfonyl)imide salt. The solvent contains at least one selected from the first group consisting of an ethylene carbonate, a propylene carbonate, a fluoroethylene carbonate, a dimethyl carbonate, and a gamma butyrolactone. The additive contains at least one of a lithium fluorophosphate, a sulfinyl compound, and a dinitrile compound. The molar ratio of the original solvent to lithium ions, which is calculated from a vibration spectrum of the electrolytic solution, is more than 0 and 1.78 or less. The lithium fluorophosphate contains at least one of a lithium monofluorophosphate (Li₂PFO₃) and a lithium difluorophosphate (LiPF₂O₂). The sulfinyl compound contains at least one of compounds represented by respective formulas (1), (2), (3), (4), (5), (6), and (7):

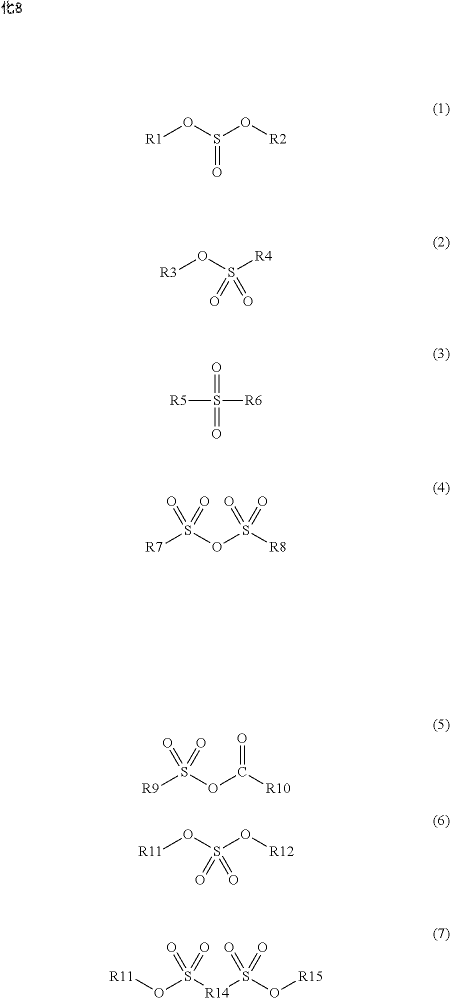

where each of R1 to R15 is any of a monovalent hydrocarbon group and a monovalent fluorinated hydrocarbon group, and R15 is any of a divalent hydrocarbon group and a divalent fluorinated hydrocarbon group, provided that R1 and R2 may be bonded to each other, R3 and R4 may be bonded to each other, R5 and R6 may be bonded to each other, R7 and R8 may be bonded to each other, R9 and R10 may be bonded to each other, and R11 and R12 may be bonded to each other.

The dinitrile compound contains a compound represented by the formula (8):

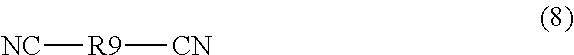

where R9 is any of an alkylene group, a phenylene group, a fluorinated alkylene group, and a fluorinated phenylene group. Thus, the charge-discharge characteristics can be improved.

As a desirable aspect, the additive contains lithium fluorophosphate. Thus, the charge-discharge characteristics can be improved.

In an embodiment, the additive contains a sulfinyl compound. Thus, the charge-discharge characteristics can be improved.

In an embodiment, the additive contains a dinitrile compound. Thus, the charge-discharge characteristics can be improved.

In an embodiment, the solvent further contains at least one of carbonic acid esters excluding the compounds included in the first group and chain carboxylic acid esters. As a result, charge-discharge characteristics can be improved.

In an embodiment, the solvent further contains at least one of a diethyl carbonate, an ethyl methyl carbonate, a propyl propionate, an ethyl propionate, a methyl propionate, a propyl acetate, an ethyl acetate, and a methyl acetate. As a result, the charge-discharge characteristics can be further improved.

In an embodiment, the solvent further contains at least one of an ethyl methyl carbonate, a propyl propionate, an ethyl propionate, a propyl acetate, an ethyl acetate, and a methyl acetate. As a result, the charge-discharge characteristics can be further improved.

In an embodiment, the content ratio of a lithium carbonate in the positive electrode active material layer 212 is more than 0.05% by mass and less than 1.0% by mass. Thus, while stabilizing the interface state between the positive electrode active material layer and the positive electrode current collector layer, the electrolytic solution is made less likely to be decomposed on the surfaces of lithium-containing compound particles, and in particular, the charge-discharge characteristics in a severe environment such as a high-temperature environment or a low-temperature environment can be improved.

In an embodiment, the content ratio of a lithium hydroxide in the positive electrode active material layer 212 is more than 0.05% by mass and less than 1.0% by mass. Thus, while stabilizing the interface state between the positive electrode active material layer and the positive electrode current collector layer, the electrolytic solution is made less likely to be decomposed on the surfaces of lithium-containing compound particles, and in particular, the charge-discharge characteristics in a severe environment such as a high-temperature environment or a low-temperature environment can be improved.

In an embodiment, the lithium-containing compound contains at least one of a first lithium composite oxide represented by the formula (9) and a second lithium composite oxide represented by the formula (10). Thus, the voltage of the secondary battery 1 can be improved, and thus, the charge-discharge characteristics can be further improved.

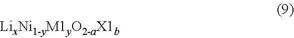

where M1 is at least one of Co, Mn, Mg, Ba, Al, B, Ti, V, Cr, Fe, Cu, Zn, Zr, Mo, Sn, Ca, Sr, W, Na, K, Nb, Ta, and a rare earth element, X1 is at least one of F, Cl, Cr, I, P, S, and Si, and x, y, a, and b satisfy 0.9≤x≤1.1, 0.005≤y≤0.5, −0.1≤a≤0.2, and 0≤b≥0.1.

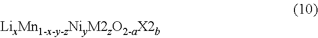

where M2 is at least one of Co, Mg, Ba, Al, B, Ti, V, Cr, Fe, Cu, Zn, Zr, Mo, Sn, Ca, Sr, W, Na, K, Nb, Ta, and a rare earth element, X2 is at least one of F, Cl, Cr, I, P, S, and Si, and x, y, z, a, and b satisfy 0<x≤0.3, 0.3≤y≤0.9, 0≤≤0.5, −0.1≤a≤0.2, and 0≤b≤0.1.

In an embodiment, the electrolytic solution contains light metal ions as cations. Also in this case, the charge-discharge characteristics can be improved. Thus, the voltage of the secondary battery 1 can be improved, and thus, the charge-discharge characteristics can be improved.

In an embodiment, the light metal ions include lithium ions. Thus, the voltage of the secondary battery 1 can be further improved, and thus, the charge-discharge characteristics can be further improved.

In an embodiment, the content ratio of a lithium bis(fluorosulfonyl)imide in the electrolytic solution is preferably 1.0 mol/kg or more and 3.0 mol/kg or less. Thus, the ion conductivity of the electrolytic solution can be improved, and the charge-discharge characteristics can be further improved.

In an embodiment, the electrolytic solution more preferably further contains at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound. Thus, the decomposition reaction of the electrolytic solution can be inhibited, and thus, the charge-discharge characteristics can be further improved.

In an embodiment, the electrolytic solution further contains at least one of a lithium hexafluorophosphate, a lithium tetrafluoroborate, a lithium bis(oxalato) borate, and a lithium difluorophosphate. Thus, the moving speed of lithium ions is further improved, and thus, the charge-discharge characteristics can be further improved.

In an embodiment, the secondary battery according to the present embodiment is a lithium ion secondary battery. Thus, occlusion and release of lithium are utilized to obtain a sufficient battery capacity in a stable manner, and thus, the charge-discharge characteristics can be further improved.

An example of a method for manufacturing the secondary battery 1 according to an embodiment will be described below. The method for manufacturing the secondary battery 1 according to an embodiment includes preparing the positive electrode 210, a step of preparing the negative electrode 220, a step of preparing the electrolytic solution, a step of assembling a laminate cell, and a charge-discharge step.

In the step of preparing the positive electrode 210, the positive electrode 210 is prepared by applying, to the positive electrode current collector 211, a positive electrode mixture slurry in which a positive electrode mixture is dispersed, followed by drying and compression forming. The positive electrode mixture is prepared by mixing a positive electrode active material, a positive electrode binder, and a positive electrode conductive agent. Then, the prepared positive electrode mixture is dispersed in a dispersion liquid such as N-methyl-2-pyrrolidone (NMP) to prepare a positive electrode mixture slurry, and then, the prepared positive electrode mixture slurry is uniformly applied to both surfaces of the positive electrode current collector 211. The applied material obtained is dried with hot air or the like, and then subjected to compression molding with a roll press machine or the like to prepare the positive electrode 210. The positive electrode lead 31 is attached to the prepared positive electrode 210 at a part where the positive electrode current collector 211 is exposed.

In the step of preparing the negative electrode 220, the negative electrode 220 is prepared by applying, to the negative electrode current collector 221, a negative electrode mixture slurry in which a negative electrode mixture is dispersed, followed by drying and compression forming. The negative electrode mixture is prepared by mixing a negative electrode active material and a negative electrode binder. The prepared negative electrode mixture is dispersed in a dispersion liquid such as NMP to prepare a negative electrode mixture slurry, and then, the negative electrode mixture is uniformly applied to both surfaces of the negative electrode current collector. The applied material obtained is dried with hot air or the like, and then subjected to compression molding with a roll press machine or the like to prepare the negative electrode 220. The negative electrode lead 32 is attached to the prepared negative electrode 220 at a part where the negative electrode current collector 221 is exposed.

In the step of preparing the electrolytic solution, the electrolytic solution is prepared by dissolving an electrolyte salt in a solvent, and adding an additive.

In the step of assembling the laminate cell, the laminate cell is assembled by preparing an electrode body, then placing the electrode body in an exterior member, and injecting the electrolytic solution to seal the exterior member. The positive electrode 210, the separator 230, and the negative electrode 220 are stacked in this order, and then wound in the longitudinal direction to prepare an electrode body. The prepared electrode body is placed in an exterior member, and three sides of the exterior member are thermally fused, such that the other one side is provided with an opening without being thermally fused. Thereafter, the electrolytic solution is injected from the opening of the exterior member, and the remaining one side of the exterior member is thermally fused in a reduced pressure environment to seal the exterior member, thereby forming a laminate cell.

In the charge-discharge step, the prepared laminate cell is charged and discharged for one cycle. The charge-discharge for one cycle can be performed, for example, under a charge-discharge condition A. The charge-discharge condition A is a condition under which first charging, first leaving to stand, second charging, second leaving to stand, and discharging are sequentially performed at a temperature of 33° C. under the following conditions. Thus, a good film can be formed on the positive electrode current collector 211, and the secondary battery 1 can be made electrochemically stable.
First charging method: CCCV
First charging rate: 0.2 C
First charge control voltage: 3.0 V
First cut-off time: 1 hour
First standing time: 12 hours
Second charging method: CCCV
Second charging rate: 0.2 C
Second charge control voltage: 4.2 V
Second cut-off time: 8 hours
Second standing time: 12 hours
Discharging method: CC
Discharging rate: 0.2 C
End-of-discharge voltage: 2.5 V

The secondary battery 1 can be manufactured in accordance with the steps described above according to an embodiment. The above-described method for manufacturing the secondary battery is an example, and the present disclosure is not limited thereto.

### EXAMPLES

Examples will be described below according to an embodiment. Note that the present disclosure is not limited by the following examples.

Table 2 is a table showing Comparative Example 1-1 to Comparative Example 1-16.

TABLE 2

| | | | | | | | Vibration | Test Results | | |
|---|---|---|---|---|---|---|---|---|---|---|
| | | | | Additive | | | Spectrum | | | Low- |
| | | | | | Content | | Measurement | | | temperature |
| | Electrolyte | | | | Ratio | Charge- | Molar Ratio | Cycle | Storage | Load |
| | Salt (mol/kg) | | Solvent | | (% by | discharge | of Original | Retention | Retention | Retention |
| | LiFSI | LiPF₆ | (mass ratio) | Type | mass) | Condition | Solvent to Lit⁺ | Ratio (%) | Ratio (%) | Ratio (%) |
| Comparative | 2.20 | 0 | EC:DMC = | — | — | B | 1.84 | 0 | 0 | 0 |
| Example 1-1 | | | 20:80 | | | | | | | |
| Comparative | 1.60 | 0 | EC:DMC = | — | — | A | 3.56 | 0 | 0 | 0 |
| Example 1-2 | | | 20:80 | | | | | | | |
| Comparative | 2.00 | 0 | EC:DMC = | — | — | A | 2.20 | 0 | 0 | 0 |
| Example 1-3 | | | 20:80 | | | | | | | |
| Comparative | 0.90 | 0 | EC:PrPr = | — | — | A | 2.46 | 0 | 0 | 0 |
| Example 1-4 | | | 34:66 | | | | | | | |
| Comparative | 1.10 | 0 | EC:PrPr = | — | — | A | 1.84 | 10 | 12 | 10 |
| Example 1-5 | | | 34:66 | | | | | | | |
| Comparative | 1.20 | 0 | EC:PrPr = | — | — | A | 1.76 | 50 | 60 | 45 |
| Example 1-6 | | | 34:66 | | | | | | | |
| Comparative | 2.00 | 0 | PrPr = 100 | — | — | A | 0.00 | 0 | 26 | 20 |
| Example 1-7 | | | | | | | | | | |
| Comparative | 3.00 | 0 | EC:PrPr = | — | — | A | 0.00 | 10 | 20 | 10 |
| Example 1-8 | | | 16:84 | | | | | | | |
| Comparative | 2.50 | 0 | EC:DMC = | — | — | A | 1.38 | 40 | 38 | 15 |
| Example 1-9 | | | 20:80 | | | | | | | |
| Comparative | 2.30 | 0 | EC:DMC = | — | — | A | 1.50 | 38 | 35 | 22 |
| Example 1-10 | | | 20:80 | | | | | | | |
| Comparative | 2.20 | 0 | EC:DMC = | — | — | A | 1.76 | 35 | 30 | 20 |
| Example 1-11 | | | 20:80 | | | | | | | |
| Comparative | 0.90 | 0 | EC:PrPr = | — | — | A | 2.46 | 0 | 0 | 0 |
| Example 1-12 | | | 34:66 | | | | | | | |
| Comparative | 1.10 | 0 | EC:PrPr = | — | — | A | 1.84 | 11 | 14 | 11 |
| Example 1-13 | | | 34:66 | | | | | | | |
| Comparative | 0.90 | 0 | EC:PrPr = | — | — | A | 2.46 | 0 | 0 | 0 |
| Example 1-14 | | | 34:66 | | | | | | | |
| Comparative | 1.10 | 0 | EC:PrPr = | — | — | A | 1.84 | 8 | 12 | 8 |
| Example 1-15 | | | 34:66 | | | | | | | |
| Comparative | 2.20 | 0 | EC:PrPr:DMC = | — | — | A | 0.54 | 38 | 45 | 42 |
| Example 1-16 | | | 17:66:17 | | | | | | | |

In the column of “charge-discharge condition” in the tables shown by Table 2 and subsequent tables, each of “A” and “B” indicates that the laminate cell was charged and discharged under each of the charge-discharge condition A and charge-discharge condition B described above in the charge-discharge step.

In this regard, the charge-discharge condition B is a condition under which charging, leaving to stand, and discharging are sequentially performed at a temperature of 30° C. under the following conditions. More specifically, unlike the charge-discharge condition A under which charging is performed two times, charging is performed one time under the charge-discharge condition B.
Charging method: CCCV
Charging rate: 0.2 C
Charge control voltage: 4.2 V
Cut-off time: 8 hours
Standing time: 5 minutes
Discharging method: CC
Discharging rate: 0.2 C
End-of-discharge voltage: 2.5 V

### Comparative Example 1-1

A positive electrode according to Comparative Example 1-1 was prepared by applying, to the positive electrode current collector 211, a positive electrode mixture slurry in which a positive electrode mixture was dispersed, followed by drying and compression forming. A powder of LiNi_{0.82}Co_{0.14}Al_{0.4}O₂, which was the first lithium composite oxide, as a positive electrode active material, a polyvinylidene fluoride (PVdF) as a positive electrode binder, and carbon black as a positive electrode conductive agent were mixed at mass ratios of 91:3:6 to prepare a positive electrode mixture. The prepared positive electrode mixture was dispersed in N-methyl-2-pyrrolidone (NMP) to prepare a positive electrode mixture slurry, a strip-shaped aluminum foil of 12 μm in thickness was then prepared as a positive electrode current collector, and the prepared positive electrode mixture slurry was uniformly applied to both surfaces of the aluminum foil. The applied material obtained was dried with hot air, and then subjected to compression molding with a roll press machine to prepare a positive electrode. A positive electrode lead was attached to the prepared positive electrode at a part where the positive electrode current collector was exposed.

A negative electrode according to Comparative Example 1-1 was prepared by applying, to the negative electrode current collector 221, a negative electrode mixture slurry in which a negative electrode mixture was dispersed, followed by drying and compression forming. Artificial graphite as a negative electrode active material and PVdF as a negative electrode binder were mixed at mass ratios of 93:7 to prepare a negative electrode mixture. The prepared negative electrode mixture was dispersed in N-methyl-2-pyrrolidone (NMP) to prepare a negative electrode mixture slurry, a copper foil of 15 μm in thickness was then prepared as a negative electrode current collector, and the negative electrode mixture was uniformly applied to both surfaces of the copper foil. The applied material obtained was dried with hot air, and then subjected to compression molding with a roll press machine to prepare a negative electrode. A negative electrode lead was attached to the prepared negative electrode at a part where the negative electrode current collector is exposed.

For a separator according to Comparative Example 1-1, a microporous polyethylene film of 15 μm in thickness was used.

An electrolytic solution according to Comparative Example 1-1 was prepared in accordance with the components and proportions shown in Table 2 for a solvent and an electrolyte salt.

A laminate cell according to Comparative Example 1-1 was assembled by preparing an electrode body, then placing the electrode body in an exterior member, and injecting the electrolytic solution to seal the exterior member. The electrode body was prepared by stacking the positive electrode and negative electrode prepared as mentioned above with the separator interposed therebetween, then bringing the electrodes and the separator into close contact with each other, and winding the stack in the longitudinal direction. The prepared electrode body was placed in an exterior member, and three sides of the exterior member were thermally fused, such that the other one side was provided with an opening without being thermally fused. For the exterior member, a laminate film was used, which was a laminate of a 25 μm thick nylon film as an outermost layer, a 40 μm thick aluminum foil as a metal layer, and a 30 μm thick polypropylene film as an insulating layer. Thereafter, the electrolytic solution prepared as mentioned above was injected from the opening of the exterior member, and the remaining one side of the exterior member was thermally fused in a reduced pressure environment to seal the exterior member, thereby forming a laminate cell.

For Comparative Example 1-1, the prepared laminate cell was charged and discharged for one cycle under the charge-discharge condition B described above. Thus, a battery according to Comparative Example 1-1 was prepared.

### <<Vibration Spectrum Measurement>>

For Comparative Example 1-1, a vibration spectrum of the electrolytic solution was measured by the following method. In the measurement of the vibration spectrum, the electrolytic solution extracted by use of a centrifugal separator from the secondary battery to be subjected to the measurement was enclosed in a glass sealed container to provide a sample. Thereafter, the sample was introduced into a Raman spectrometer (manufactured by Nanophoton Corporation), and subjected to measurement at 758 nm as the wavelength of an excitation laser for the measurement. Then, based on the respectively obtained peak intensity I. and peak intensity Iₛ of the original solvent and of the solvent of the solvate, the amount of substance M₀ of the original solvent was calculated by the formula (1) described above, and the molar ratio of the original solvent to lithium ions was calculated. Since the electrolytic solution according to Comparative Example 1-1 contains multiple types of solvents, the amount of substance M₀ of the solvent was calculated by the formula (1) described above for each type of the solvents, and the weighted average weighted with the molar ratios of the multiple types of solvents was calculated to calculate the amount of substance of the original solvent. As a result, the molar ratio of the original solvent to lithium ions was the value shown in Table 2.

### <<Cycle Characteristics Test>>

For Comparative Example 1-1, a cycle characteristics test was performed.

In the cycle characteristics test, the secondary battery prepared as mentioned above was charged and discharged for 100 cycles under the following conditions in an environment at 60° C., and the discharge capacity in the 1st cycle and the discharge capacity in the 100th cycle were measured. The ratio of the discharge capacity in the 100th cycle to the discharge capacity in the 1st cycle was calculated as a cycle retention ratio. More specifically, the cycle retention ratio was calculated based on the calculation formula: cycle retention ratio (%)=(discharge capacity in 100th cycle/discharge capacity in 1st cycle)×100.
Charging method: CCCV
Charging rate: 0.1 C
Charge control voltage: 4.2 V
End-of-charge current: 0.05 C
Discharging method: CC
Discharging rate: 0.1 C
End-of-discharge voltage: 2.5 V

### <<Storage Characteristics Test>>

For Comparative Example 1-1, a storage characteristics test was performed.

In the storage characteristics test, the secondary battery prepared as mentioned above was charged and discharged for the 1st cycle under the following conditions in an environment at 23° C., and the discharge capacity before storage was measured.
Charging method: CCCV
Charging rate: 0.1 C
Charge control voltage: 4.2 V
End-of-charge current: 0.05 C
Discharging method: CC
Discharging rate: 0.1 C
End-of-discharge voltage: 2.5 V

Thereafter, the battery was allowed to stand in a thermostatic chamber, stored in an environment at 80° C. for 10 days, and then discharged under the following conditions, and the discharge capacity after the storage was measured. The charging and the discharging were performed in an environment at 23° C. The ratio of the discharge capacity before the storage to the discharge capacity after the storage was calculated as a storage retention ratio. More specifically, the storage retention ratio was calculated based on the calculation formula: storage retention ratio (%)=(discharge capacity after storage/discharge capacity before storage)×100.
Discharging method: CC
Discharging rate: 0.1 C
End-of-discharge voltage: 2.5 V

### <<Low-temperature Load Characteristics Test>>

For Comparative Example 1-1, a low-temperature load characteristics test was performed.

In the low-temperature load characteristics test, the secondary battery prepared as mentioned above was charged and discharged for the 1st cycle under the following conditions in an environment at 23° C. Thereafter, the secondary battery was charged and discharged from the 2nd cycle to the 100th cycle in an environment at −10° C. under the following conditions in the same manner as the charge-discharge for the 1st cycle. The ratio of the discharge capacity in the 100th cycle to the discharge capacity in the 1st cycle was calculated as a low-temperature load retention ratio. More specifically, the low-temperature load retention ratio was calculated based on the calculation formula: low-temperature load retention ratio (%)=(discharge capacity in 100th cycle/discharge capacity in 1st cycle)×100.
Charging method: CCCV
Charging rate: 0.1 C
Charge control voltage: 4.2 V
End-of-charge current: 0.05 C
Discharging method: CC
Discharging rate: 0.1 C
End-of-discharge voltage: 2.5 V

### Comparative Example 1-2 to Comparative Example 1-16

In Comparative Example 1-2 to Comparative Example 1-16, secondary batteries were prepared, and subjected to the measurement and the tests in the same manner as the battery according to Comparative Example 1-1, except that electrolytic solutions were prepared by dissolving LiFSI as an electrolyte salt in solvents obtained by mixing the components shown in Table 2 as solvents at the mass ratios shown in Table 2 so as to reach the concentrations shown in Table 2, and that the batteries were charged and discharged under the above-described charge-discharge condition A to prepare the batteries.

As shown in Table 2, in comparison between Comparative Example 1-1 and Comparative Example 1-11, it has been determined that Comparative Example 1-1 and Comparative Example 1-11 differ in the molar ratio of the original solvent to lithium ions due to the different charge-discharge conditions, although the electrolytic solutions have the same composition. This indicates that the chemical state of a part of the constituent species (solvent and electrolyte) of the electrolytic solution is changed by the charge-discharge step, thus changing the state of the electrolytic solution depending on the charge-discharge conditions.

Table 3 is a table showing Example 2-1 to Example 2-28 and Comparative Example 2-1 to Comparative Example 2-4.

TABLE 3

| | | | | | | | Vibration | | | |
|---|---|---|---|---|---|---|---|---|---|---|
| | | | | | | | Spectrum | Test Results | | |
| | | | | Additive | | | Measurement | | | Low- |
| | | | | | Content | | Molar Ratio | | | temperature |
| | Electrolyte | | | | Ratio | Charge- | of Original | Cycle | Storage | Load |
| | Salt (mol/kg) | | Solvent | | (% by | discharge | Solvent to | Retention | Retention | Retention |
| | LiFSI | LiPF₆ | (mass ratio) | Type | mass) | Condition | Li⁺ | Ratio (%) | Ratio (%) | Ratio (%) |
| Example 2-1 | 2.50 | 0 | EC:DMC = | LiPF₂O₂ | 1.00 | A | 1.36 | 65 | 60 | 30 |
| | | | 20:80 | | | | | | | |
| Example 2-2 | 2.30 | 0 | EC:DMC = | LiPF₂O₂ | 1.00 | A | 1.47 | 56 | 55 | 35 |
| | | | 20:80 | | | | | | | |
| Example 2-3 | 2.20 | 0 | EC:DMC = | LiPF₂O₂ | 1.00 | A | 1.78 | 55 | 55 | 35 |
| | | | 20:80 | | | | | | | |
| Example 2-4 | 2.00 | 0 | EC:PrPr = | LiPF₂O₂ | 1.00 | A | 0.96 | 68 | 62 | 35 |
| | | | 53:47 | | | | | | | |
| Comparative | 0.90 | 0 | EC:PrPr = | LiPF₂O₂ | 1.00 | A | 2.44 | 0 | 0 | 0 |
| Example 2-1 | | | 34:66 | | | | | | | |
| Comparative | 1.10 | 0 | EC:PrPr = | LiPF₂O₂ | 1.00 | A | 1.86 | 10 | 12 | 10 |
| Example 2-2 | | | 34:66 | | | | | | | |
| Example 2-5 | 1.20 | 0 | EC:PrPr = | LiPF₂O₂ | 1.00 | A | 1.78 | 68 | 75 | 50 |
| | | | 34:66 | | | | | | | |
| Comparative | 2.00 | 0 | PrPr = 100 | LiPF₂O₂ | 1.00 | A | 0.00 | 0 | 28 | 20 |
| Example 2-3 | | | | | | | | | | |
| Comparative | 3.00 | 0 | EC:PrPr = | LiPF₂O₂ | 1.00 | A | 0.00 | 10 | 22 | 10 |
| Example 2-4 | | | 16:84 | | | | | | | |
| Example 2-6 | 2.00 | 0 | EC:PrPr = | LiPF₂O₂ | 1.00 | A | 0.52 | 78 | 78 | 50 |
| | | | 34:66 | | | | | | | |
| Example 2-7 | 2.10 | 0 | EC:PrEt = | LiPF₂O₂ | 1.00 | A | 0.66 | 80 | 80 | 60 |
| | | | 37:63 | | | | | | | |
| Example 2-8 | 2.10 | 0 | EC:AcPr = | LiPF₂O₂ | 1.00 | A | 0.73 | 79 | 79 | 59 |
| | | | 37:63 | | | | | | | |
| Example 2-9 | 2.10 | 0 | EC:PrEt = | LiPF₂O₂ | 1.00 | A | 0.20 | 88 | 86 | 82 |
| | | | 18:82 | | | | | | | |
| Example 2-10 | 2.10 | 0 | EC:AcPr = | LiPF₂O₂ | 1.00 | A | 0.34 | 87 | 85 | 78 |
| | | | 18:82 | | | | | | | |
| Example 2-11 | 2.10 | 0 | EC:AcMe = | LiPF₂O₂ | 1.00 | A | 0.36 | 84 | 80 | 84 |
| | | | 18:82 | | | | | | | |
| Example 2-12 | 2.10 | 0 | EC:AcEt = | LiPF₂O₂ | 1.00 | A | 0.44 | 82 | 78 | 87 |
| | | | 18:82 | | | | | | | |
| Example 2-13 | 2.20 | 0 | EC:PC:DMC:PrPr = | LiPF₂O₂ | 1.00 | A | 0.81 | 90 | 94 | 70 |
| | | | 6:14:35:45 | | | | | | | |
| Example 2-14 | 2.20 | 0 | EC:GBL:DMC:PrPr = | LiPF₂O₂ | 1.00 | A | 0.86 | 88 | 90 | 74 |
| | | | 6:14:35:45 | | | | | | | |
| Example 2-15 | 2.20 | 0 | EC:FEC:DMC:PrPr = | LiPF₂O₂ | 1.00 | A | 0.79 | 92 | 92 | 68 |
| | | | 6:14:35:45 | | | | | | | |
| Example 2-16 | 2.20 | 0 | EC:FEC:DMC:PrEt = | LiPF₂O₂ | 1.00 | A | 0.81 | 92 | 94 | 84 |
| | | | 7:14:42:37 | | | | | | | |
| Example 2-17 | 1.80 | 0.20 | EC:FEC:DMC:PrPr = | LiPF₂O₂ | 1.00 | A | 1.31 | 90 | 88 | 64 |
| | | | 7:13:57:23 | | | | | | | |
| Example 2-18 | 1.60 | 0.40 | EC:FEC:DMC:PrPr = | LiPF₂O₂ | 1.00 | A | 1.31 | 90 | 90 | 63 |
| | | | 7:13:57:23 | | | | | | | |
| Example 2-19 | 1.20 | 0.80 | EC:FEC:DMC:PrPr = | LiPF₂O₂ | 1.00 | A | 1.28 | 89 | 92 | 62 |
| | | | 7:13:57:23 | | | | | | | |
| Example 2-20 | 2.20 | 0 | EC:PrEt:DMC = | LiPF₂O₂ | 1.00 | A | 0.61 | 90 | 88 | 81 |
| | | | 17:66:17 | | | | | | | |
| Example 2-21 | 2.20 | 0 | EC:AcPr:DMC = | LiPF₂O₂ | 1.00 | A | 0.63 | 88 | 87 | 78 |
| | | | 17:66:17 | | | | | | | |
| Example 2-22 | 2.20 | 0 | EC:AcMe:DMC = | LiPF₂O₂ | 1.00 | A | 0.70 | 86 | 82 | 84 |
| | | | 17:66:17 | | | | | | | |
| Example 2-23 | 2.20 | 0 | EC:AcEt:DMC = | LiPF₂O₂ | 1.00 | A | 0.66 | 86 | 82 | 84 |
| | | | 17:66:17 | | | | | | | |
| Example 2-24 | 2.20 | 0 | EC:PrPr:DMC = | LiPF₂O₂ | 1.00 | A | 0.52 | 88 | 86 | 64 |
| | | | 17:66:17 | | | | | | | |
| Example 2-25 | 2.20 | 0 | EC:PrPr:DMC = | LiPF₂O₂ | 0.05 | A | 0.54 | 83 | 84 | 58 |
| | | | 17:66:17 | | | | | | | |
| Example 2-26 | 2.20 | 0 | EC:PrPr:DMC = | LiPF₂O₂ | 0.50 | A | 0.54 | 85 | 88 | 58 |
| | | | 17:66:17 | | | | | | | |
| Example 2-27 | 2.20 | 0 | EC:PrPr:DMC = | LiPF₂O₂ | 3.00 | A | 0.50 | 86 | 90 | 55 |
| | | | 17:66:17 | | | | | | | |
| Example 2-28 | 2.20 | 0 | EC:PrPr:DMC = | Li₂PFO₃ | 1.00 | A | 0.51 | 73 | 75 | 61 |
| | | | 17:66:17 | | | | | | | |

### Example 2-1 to Example 2-16, Example 2-20 to Example 2-28, and Comparative Example 2-1 to Comparative Example 2-4

In Example 2-1 to Example 2-16, Example 2-20 to Example 2-28, and Comparative Example 2-1 to Comparative Example 2-4, secondary batteries were prepared, and subjected to the measurement and the tests in the same manner as the battery according to Comparative Example 1-1, except that electrolytic solutions were prepared by dissolving LiFSI as an electrolyte salt in solvents obtained by mixing the components shown in Table 3 as solvents at the mass ratios shown in Table 3 so as to reach the concentrations shown in Table 3, and dissolving, as an additive, the lithium fluorophosphate shown in Table 3 so as to reach the content ratios shown in Table 3, and that the batteries were charged and discharged under the above-described charge-discharge condition A to prepare the batteries.

### Example 2-17 to Example 2-19

In Example 2-17 to Example 2-19, secondary batteries were prepared, and subjected to the measurement and the tests in the same manner as the battery according to Example 2-1, except that electrolytic solutions were prepared by dissolving each of LiFSI and LiPF₆ as an electrolyte salt in solvents obtained by mixing the components shown in Table 3 as solvents at the mass ratios shown in Table 3 so as to reach the concentrations shown in Table 3, and dissolving the additive shown in Table 3 so as to reach the content ratio shown in Table 3, for preparing the batteries.

As shown in Tables 2 and 3, Examples 2-1 to 2-28 with the electrolytic solution containing the lithium fluorophosphate as an additive have cycle retention ratios and storage retention ratios improved as compared with Comparative Examples 1-1 to 1-16 containing no additive. Accordingly, it is determined that the electrolytic solution contains the lithium fluorophosphate as an additive, thereby allowing the charge-discharge characteristics to be improved.

As shown in Table 3, Examples 2-1 to 2-28 with the molar ratio of the original solvent to lithium ions being more than 0 and 1.78 or less have cycle retention ratios and storage retention ratios improved as compared with Comparative Examples 2-1 to 2-4 with the molar ratio of the original solvent to lithium ions being 0 or more than 1.78. Accordingly, it is determined that the molar ratio of the original solvent to lithium ions is more than 0 and 1.78 or less, thereby allowing the charge-discharge characteristics to be improved.

As shown in Table 3, Examples 2-4 to 2-28 with the solvent further containing at least one of carbonic acid esters (DEC, EMC) excluding EC, FEC, and DMC included in the first group and chain carboxylic acid esters (PrPr, PrEt, AcPr, AcEt, AcMe) have charge-discharge characteristics further improved as compared with Examples 2-1 to 2-3 with the solvents composed of EC and DMC included in the first group. Accordingly, it is determined that the solvent further contains at least one of carbonic acid esters excluding the compounds included in the first group and chain carboxylic acid esters, thereby allowing the charge-discharge characteristics to be further improved.

As shown in Table 3, Examples 2-4 to 2-28 with the solvent further containing at least one of DEC, EMC, PrPr, PrEt, AcPr, AcEt, and AcMe, have charge-discharge characteristics further improved as compared with Example 2-1 to Example 2-3 with the solvents containing no DEC, EMC, PrPr, PrEt, AcPr, AcEt, or AcMe. Accordingly, it is determined that the solvent further contains at least one of DEC, EMC, PrPr, PrEt, AcPr, AcEt, and AcMe, thereby allowing the charge-discharge characteristics to be further improved.

As shown in Table 3, Examples 2-4 to 2-28 with the solvent further containing at least one of EMC, PrPr, PrEt, AcPr, AcEt, and AcMe have low-temperature load characteristics further improved as compared with Examples 2-1 to 2-3 with the solvents containing no PrPr, PrEt, AcPr, AcEt, or AcMe. Accordingly, it is determined that the solvent further contains at least one of EMC, PrPr, PrEt, AcPr, AcEt, and AcMe, thereby allowing the charge-discharge characteristics to be further improved.

Table 4 is a table showing Example 3-1 to Example 3-34 and Comparative Example 3-1 to Comparative Example 3-4.

TABLE 4

| | | | | | | | Vibration | | | |
|---|---|---|---|---|---|---|---|---|---|---|
| | | | | | | | Spectrum | Test Results | | |
| | | | | Additive | | | Measurement | | | Low- |
| | | | | | Content | | Molar Ratio | | | temperature |
| | Electrolyte | | | | Ratio | Charge- | of Original | Cycle | Storage | Load |
| | Salt (mol/kg) | | Solvent | | (% by | discharge | Solvent to | Retention | Retention | Retention |
| | LiFSI | LiPF₆ | (mass ratio) | Type | mass) | Condition | Li⁺ | Ratio (%) | Ratio (%) | Ratio (%) |
| Example 3-1 | 2.50 | 0 | EC:DMC = 20:80 | Formula | 1.00 | A | 1.38 | 75 | 66 | 36 |
| | | | | (4-2) | | | | | | |
| Example 3-2 | 2.30 | 0 | EC:DMC = 20:80 | Formula | 1.00 | A | 1.50 | 66 | 61 | |
| | | | | (4-2) | | | | | | |
| Example 3-3 | 2.20 | 0 | EC:DMC = 20:80 | Formula | 1.00 | A | 1.78 | 65 | 61 | 41 |
| | | | | (4-2) | | | | | | |
| Example 3-4 | 2.00 | 0 | EC:PrPr = 53:47 | Formula | 1.00 | A | 0.98 | 78 | 68 | 41 |
| | | | | (4-2) | | | | | | |
| Comparative | 0.90 | 0 | EC:PrPr = 34:66 | Formula | 1.00 | A | 2.46 | 0 | 0 | 0 |
| Example 3-1 | | | | (4-2) | | | | | | |
| Comparative | 1.10 | 0 | EC:PrPr = 34:66 | Formula | 1.00 | A | 1.86 | 12 | 14 | 11 |
| Example 3-2 | | | | (4-2) | | | | | | |
| Example 3-5 | 1.20 | 0 | EC:PrPr = 34:66 | Formula | 1.00 | A | 1.78 | 68 | 72 | 52 |
| | | | | (4-2) | | | | | | |
| Comparative | 2.00 | 0 | PrPr = 100 | Formula | 1.00 | A | 0.00 | 0 | 26 | 18 |
| Example 3-3 | | | | (4-2) | | | | | | |
| Comparative | 3.00 | 0 | EC:PrPr = 16:84 | Formula | 1.00 | A | 0.00 | 10 | 18 | 10 |
| Example 3-4 | | | | (4-2) | | | | | | |
| Example 3-6 | 2.00 | 0 | EC:PrPr = 34:66 | Formula | 1.00 | A | 0.55 | 88 | 84 | 56 |
| | | | | (4-2) | | | | | | |
| Example 3-7 | 2.10 | 0 | EC:PrEt = 37:63 | Formula | 1.00 | A | 0.68 | 90 | 86 | 66 |
| | | | | (4-2) | | | | | | |
| Example 3-8 | 2.10 | 0 | EC:AcPr = 37:63 | Formula | 1.00 | A | 0.73 | 89 | 85 | 65 |
| | | | | (4-2) | | | | | | |
| Example 3-9 | 2.10 | 0 | EC:PrEt = 18:82 | Formula | 1.00 | A | 0.22 | 93 | 89 | 82 |
| | | | | (4-2) | | | | | | |
| Example 3-10 | 2.10 | 0 | EC:AcPr = 18:82 | Formula | 1.00 | A | 0.36 | 92.5 | 88.5 | 80 |
| | | | | (4-2) | | | | | | |
| Example 3-11 | 2.10 | 0 | EC:AcMe = 18:82 | Formula | 1.00 | A | 0.38 | 91 | 86 | 83 |
| | | | | (4-2) | | | | | | |
| Example 3-12 | 2.10 | 0 | EC:AcEt = 18:82 | Formula | 1.00 | A | 0.46 | 90 | 85 | 84.5 |
| | | | | (4-2) | | | | | | |
| Example 3-13 | 2.20 | 0 | EC:PC:DMC:PrPr = | Formula | 1.00 | A | 0.81 | 92 | 94 | 70 |
| | | | 6:14:35:45 | (4-2) | | | | | | |
| Example 3-14 | 2.20 | 0 | EC:GBL:DMC:PrPr = | Formula | 1.00 | A | 0.86 | 89 | 90 | 74 |
| | | | 6:14:35:45 | (4-2) | | | | | | |
| Example 3-15 | 2.20 | 0 | EC:FEC:DMC:PrPr = | Formula | 1.00 | A | 0.79 | 94 | 93 | 67 |
| | | | 6:14:35:45 | (4-2) | | | | | | |
| Example 3-16 | 2.20 | 0 | EC:FEC:DMC:PrEt = | Formula | 1.00 | A | 0.81 | 94 | 94 | 83 |
| | | | 7:14:42:37 | (4-2) | | | | | | |
| Example 3-17 | 1.80 | 0.20 | EC:FEC:DMC:PrPr = | Formula | 1.00 | A | 1.31 | 92 | 90 | 62 |
| | | | 7:13:57:23 | (4-2) | | | | | | |
| Example 3-18 | 1.60 | 0.40 | EC:FEC:DMC:PrPr = | Formula | 1.00 | A | 1.31 | 92 | 92 | 62 |
| | | | 7:13:57:23 | (4-2) | | | | | | |
| Example 3-19 | 1.20 | 0.80 | EC:FEC:DMC:PrPr = | Formula | 1.00 | A | 1.28 | 89 | 93 | 60 |
| | | | 7:13:57:23 | (4-2) | | | | | | |
| Example 3-20 | 2.10 | 0 | EC:PrEt:DMC = | Formula | 1.00 | A | 0.63 | 94 | 90 | 81.5 |
| | | | 17:66:17 | (4-2) | | | | | | |
| Example 3-21 | 2.10 | 0 | EC:AcPr:DMC = | Formula | 1.00 | A | 0.65 | 93 | 89.5 | 8 C |
| | | | 17:66:17 | (4-2) | | | | | | |
| Example 3-22 | 2.10 | 0 | EC:AcMe:DMC = | Formula | 1.00 | A | 0.72 | 92 | 87 | 83 |
| | | | 17:66:17 | (4-2) | | | | | | |
| Example 3-23 | 2.10 | 0 | EC:AcEt:DMC = | Formula | 1.00 | A | 0.68 | 92 | 87 | 83 |
| | | | 17:66:17 | (4-2) | | | | | | |
| Example 3-24 | 2.20 | 0 | EC:PrPr:DMC = | Formula | 1.00 | A | 0.54 | 90 | 91 | 68 |
| | | | 17:66:17 | (4-2) | | | | | | |
| Example 3-25 | 2.20 | 0 | EC:PrPr:DMC = | Formula | 0.05 | A | 0.54 | 85 | 85 | 6C |
| | | | 17:66:17 | (4-2) | | | | | | |
| Example 3-26 | 2.20 | 0 | EC:PrPr:DMC = | Formula | 0.50 | A | 0.54 | 88 | 88 | 65 |
| | | | 17:66:17 | (4-2) | | | | | | |
| Example 3-27 | 2.20 | 0 | EC:PrPr:DMC = | Formula | 3.00 | A | 0.54 | 88 | 91 | 64 |
| | | | 17:66:17 | (4-2) | | | | | | |
| Example 3-28 | 2.20 | 0 | EC:PrPr:DMC = | Formula | 1.00 | A | 0.54 | 85 | 84 | 60 |
| | | | 17:66:17 | (1-1) | | | | | | |
| Example 3-29 | 2.20 | 0 | EC:PrPr:DMC = | Formula | 1.00 | A | 0.54 | 88 | 90 | 62 |
| | | | 17:66:17 | (2-1) | | | | | | |
| Example 3-30 | 2.20 | 0 | EC:PrPr:DMC = | Formula | 1.00 | A | 0.54 | 87 | 90 | 60 |
| | | | 17:66:17 | (2-4) | | | | | | |
| Example 3-31 | 2.20 | 0 | EC:PrPr:DMC = | Formula | 1.00 | A | 0.54 | 82 | 90 | 55 |
| | | | 17:66:17 | (3-1) | | | | | | |
| Example 3-32 | 2.20 | 0 | EC:PrPr:DMC = | Formula | 1.00 | A | 0.54 | 88 | 90 | 60 |
| | | | 17:66:17 | (5-1) | | | | | | |
| Example 3-33 | 2.20 | 0 | EC:PrPr:DMC = | Formula | 1.00 | A | 0.54 | 88 | 90 | 65 |
| | | | 17:66:17 | (6-6) | | | | | | |
| Example 3-34 | 2.20 | 0 | EC:PrPr:DMC = | Formula | 1.00 | A | 0.54 | 88 | 90 | 65 |
| | | | 17:66:17 | (7-1) | | | | | | |

### Example 3-1 to Example 3-16, Example 3-20 to Example 3-34, and Comparative Example 3-1 to Comparative Example 3-4

In Example 3-1 to Example 3-16, Example 3-20 to Example 3-34, and Comparative Example 3-1 to Comparative Example 3-4, secondary batteries were prepared, and subjected to the measurement and the tests in the same manner as the battery according to Comparative Example 1-1, except that electrolytic solutions were prepared by dissolving LiFSI as an electrolyte salt in solvents obtained by mixing the components shown in Table 4 as solvents at the mass ratios shown in Table 4 so as to reach the concentrations shown in Table 4, and dissolving, as an additive, the sulfinyl compounds shown in Table 4 so as to reach the content ratios shown in Table 4, and that the batteries were charged and discharged under the above-described charge-discharge condition A to prepare the batteries.

### Example 3-17 to Example 3-19

In Example 3-17 to Example 3-19, secondary batteries were prepared, and subjected to the measurement and the tests in the same manner as the battery according to Example 3-1, except that electrolytic solutions were prepared by dissolving each of LiFSI and LiPF₆ as an electrolyte salt in solvents obtained by mixing the components shown in Table 4 as solvents at the mass ratios shown in Table 4 so as to reach the concentrations shown in Table 4, and dissolving the additive shown in Table 4 so as to reach the content ratio shown in Table 4, for preparing the batteries.

As shown in Tables 2 and 4, Examples 3-1 to 3-34 with the electrolytic solution containing the sulfinyl compound as an additive have cycle retention ratios and storage retention ratios improved as compared with Comparative Examples 1-1 to 1-16 containing no additive. Accordingly, it is determined that the electrolytic solution contains the sulfinyl compound as an additive, thereby allowing the charge-discharge characteristics to be improved.

As shown in Table 4, Examples 3-1 to 3-34 with the molar ratio of the original solvent to lithium ions being more than 0 and 1.78 or less have cycle retention ratios and storage retention ratios improved as compared with Comparative Examples 3-1 to 3-4 with the molar ratio of the original solvent to lithium ions being 0 or more than 1.78. Accordingly, it is determined that the molar ratio of the original solvent to lithium ions is more than 0 and 1.78 or less, thereby allowing the charge-discharge characteristics to be improved.

As shown in Table 4, Examples 3-4 to 3-34 with the solvent further containing at least one of carbonic acid esters (DEC, EMC) excluding EC, FEC, and DMC included in the first group and chain carboxylic acid esters (PrPr, PrEt, AcPr, AcEt, AcMe) have cycle retention ratios further improved as compared with Examples 3-1 to 3-3 with the solvents composed of EC and DMC included in the first group. Accordingly, it is determined that the solvent further contains at least one of carbonic acid esters excluding the compounds included in the first group and chain carboxylic acid esters, thereby allowing the charge-discharge characteristics to be further improved.

As shown in Table 4, Examples 3-4 to 3-34 with the solvent further containing at least one of DEC, EMC, PrPr, PrEt, AcPr, AcEt, and AcMe, have charge-discharge characteristics further improved as compared with Example 3-1 to Example 3-3 with the solvents containing no DEC, EMC, PrPr, PrEt, AcPr, AcEt, or AcMe. Accordingly, it is determined that the solvent further contains at least one of DEC, EMC, PrPr, PrEt, AcPr, AcEt, and AcMe, thereby allowing the charge-discharge characteristics to be further improved.

As shown in Table 4, Examples 3-4 to 3-34 with the solvent further containing at least one of EMC, PrPr, PrEt, AcPr, AcEt, and AcMe have low-temperature load characteristics further improved as compared with Examples 3-1 to 3-3 with the solvents containing no PrPr, PrEt, AcPr, AcEt, or AcMe.

Accordingly, it is determined that the solvent further contains at least one of EMC, PrPr, PrEt, AcPr, AcEt, and AcMe, thereby allowing the charge-discharge characteristics to be further improved.

Table 5 is a table showing Example 4-1 to Example 4-29 and Comparative Example 4-1 to Comparative Example 4-4.

TABLE 5

| | | | | | | | Vibration | | | |
|---|---|---|---|---|---|---|---|---|---|---|
| | | | | | | | Spectrum | Test Results | | |
| | | | | Additive | | | Measurement | | | Low- |
| | | | | | Content | | Molar Ratio | | | temperature |
| | Electrolyte | | | | Ratio | Charge- | of Original | Cycle | Storage | Load |
| | Salt (mol/kg) | | Solvent | | (% by | discharge | Solvent to | Retention | Retention | Retention |
| | LiFSI | LiPF₆ | (mass ratio) | Type | mass ) | Condition | Li⁺ | Ratio (%) | Ratio (%) | Ratio (%) |
| Example 4-1 | 2.50 | 0 | EC:DMC = 20:80 | SN | 1.00 | A | 1.38 | 59 | 57 | 28 |
| Example 4-2 | 2.30 | 0 | EC:DMC = 20:80 | SN | 1.00 | A | 1.50 | 50 | 52 | 33 |
| Example 4-3 | 2.20 | 0 | EC:DMC = 20:80 | SN | 1.00 | A | 1.77 | 49 | 52 | 33 |
| Example 4-4 | 2.00 | 0 | EC:PrPr = 53:47 | SN | 1.00 | A | 0.98 | 62 | 59 | 33 |
| Comparative | 0.90 | 0 | EC:PrPr = 34:66 | SN | 1.00 | A | 2.46 | 0 | 0 | 0 |
| Example 4-1 | | | | | | | | | | |
| Comparative | 1.10 | 0 | EC:PrPr = 34:66 | SN | 1.00 | A | 1.88 | 8 | 12 | 10 |
| Example 4-2 | | | | | | | | | | |
| Example 4-5 | 1.20 | 0 | EC:PrPr = 34:66 | SN | 1.00 | A | 1.78 | 62 | 72 | 52 |
| Comparative | 2.00 | 0 | PrPr = 100 | SN | 1.00 | A | 0.00 | 0 | 28 | 18 |
| Example 4-3 | | | | | | | | | | |
| Comparative | 3.00 | 0 | EC:PrPr = 16:84 | SN | 1.00 | A | 0.00 | 8 | 22 | 8 |
| Example 4-4 | | | | | | | | | | |
| Example 4-6 | 2.00 | 0 | EC:PrPr = 34:66 | SN | 1.00 | A | 0.55 | 72 | 75 | 48 |
| Example 4-7 | 2.10 | 0 | EC:PrEt = 37:63 | SN | 1.00 | A | 0.68 | 80 | 80 | 60 |
| Example 4-8 | 2.10 | 0 | EC:AcPr = 37:63 | SN | 1.00 | A | 0.73 | 79 | 79 | 59 |
| Example 4-9 | 2.10 | 0 | EC:PrEt = 18:82 | SN | 1.00 | A | 0.22 | 83 | 83 | 76 |
| Example 4-10 | 2.10 | 0 | EC:AcPr = 18:82 | SN | 1.00 | A | 0.36 | 82.5 | 82.5 | 74 |
| Example 4-11 | 2.10 | 0 | EC:AcMe = 18:82 | SN | 1.00 | A | 0.38 | 81 | 80 | 77 |
| Example 4-12 | 2.10 | 0 | EC:AcEt = 18:82 | SN | 1.00 | A | 0.46 | 80 | 79 | 78.5 |
| Example 4-13 | 2.20 | 0 | EC:PC:DMC:PrPr = 6:14:35:45 | SN | 1.00 | A | 0.81 | 82 | 92 | 70 |
| Example 4-14 | 2.20 | 0 | EC:GBL:DMC:PrPr = 6:14:35:45 | SN | 1.00 | A | 0.86 | 80 | 86 | 74 |
| Example 4-15 | 2.20 | 0 | EC:FEC:DMC:PrPr = 6:14:35:45 | SN | 1.00 | A | 0.79 | 86 | 89 | 66 |
| Example 4-16 | 2.20 | 0 | EC:FEC:DMC:PrEt = 7:14:42:37 | SN | 1.00 | A | 0.81 | 86 | 91 | 82 |
| Example 4-17 | 1.80 | 0.20 | EC:FEC:DMC:PrPr = 7:13:57:23 | SN | 1.00 | A | 1.31 | 84 | 85 | 62 |
| Example 4-18 | 1.60 | 0.40 | EC:FEC:DMC:PrPr = 7:13:57:23 | SN | 1.00 | A | 1.31 | 84 | 87 | 61 |
| Example 4-19 | 1.20 | 0.80 | EC:FEC:DMC:PrPr = 7:13:57:23 | SN | 1.00 | A | 1.28 | 83 | 89 | 60 |
| Example 4-20 | 2.10 | 0 | EC:PrEt:DMC = 17:66:17 | SN | 1.00 | A | 0.63 | 84 | 84 | 75.5 |
| Example 4-21 | 2.10 | 0 | EC:AcPr:DMC = 17:66:17 | SN | 1.00 | A | 0.65 | 83 | 83.5 | 74 |
| Example 4-22 | 2.10 | 0 | EC:AcMe:DMC = 17:66:17 | SN | 1.00 | A | 0.72 | 82 | 81 | 77 |
| Example 4-23 | 2.10 | 0 | EC:AcEt:DMC = 17:66:17 | SN | 1.00 | A | 0.68 | 82 | 81 | 77 |
| Example 4-24 | 2.20 | 0 | EC:PrPr:DMC = 17:66:17 | SN | 1.00 | A | 0.54 | 80 | 85 | 62 |
| Example 4-25 | 2.20 | 0 | EC:PrPr:DMC = 17:66:17 | SN | 0.05 | A | 0.54 | 75 | 79 | 54 |
| Example 4-26 | 2.20 | 0 | EC:PrPr:DMC = 17:66:17 | SN | 0.50 | A | 0.54 | 78 | 82 | 59 |
| Example 4-27 | 2.20 | 0 | EC:PrPr:DMC = 17:66:17 | SN | 2.00 | A | 0.54 | 81 | 88 | 62 |
| Example 4-28 | 2.20 | 0 | EC:PrPr:DMC = 17:66:17 | SN | 3.00 | A | 0.54 | 78 | 85 | 58 |
| Example 4-29 | 2.20 | 0 | EC:PrPr:DMC = 17:66:17 | ADN | 1.00 | A | 0.54 | 82 | 88 | 63 |

### Example 4-1 to Example 4-16, Example 4-20 to Example 4-29, and Comparative Example 4-1 to Comparative Example 4-4

In Example 4-1 to Example 4-16, Example 4-20 to Example 4-29, and Comparative Example 4-1 to Comparative Example 4-4, secondary batteries were prepared, and subjected to the measurement and the tests in the same manner as the battery according to Comparative Example 1-1, except that electrolytic solutions were prepared by dissolving LiFSI as an electrolyte salt in solvents obtained by mixing the components shown in Table 5 as solvents at the mass ratios shown in Table 5 so as to reach the concentrations shown in Table 5, and dissolving, as an additive, the dinitrile compounds shown in Table 5 so as to reach the content ratios shown in Table 5, and that the batteries were charged and discharged under the above-described charge-discharge condition A to prepare the batteries.

### Example 4-17 to Example 4-19

In Example 4-17 to Example 4-19, secondary batteries were prepared, and subjected to the measurement and the tests in the same manner as the battery according to Example 4-1, except that electrolytic solutions were prepared by dissolving each of LiFSI and LiPF₆ as an electrolyte salt in solvents obtained by mixing the components shown in Table 5 as solvents at the mass ratios shown in Table 5 so as to reach the concentrations shown in Table 5, and dissolving the additive shown in Table 5 so as to reach the content ratio shown in Table 5, for preparing the batteries.

As shown in Tables 2 and 5, Examples 4-1 to 4-29 with the electrolytic solution containing the dinitrile compound as an additive have cycle retention ratios and storage retention ratios improved as compared with Comparative Examples 1-1 to 1-16 containing no additive. Accordingly, it is determined that the electrolytic solution contains the dinitrile compound as an additive, thereby allowing the charge-discharge characteristics to be improved.

As shown in Table 5, Examples 4-1 to 4-29 with the molar ratio of the original solvent to lithium ions being more than 0 and 1.78 or less have cycle retention ratios and storage retention ratios improved as compared with Comparative Examples 4-1 to 4-4 with the molar ratio of the original solvent to lithium ions being 0 or more than 1.78. Accordingly, it is determined that the molar ratio of the original solvent to lithium ions is more than 0 and 1.78 or less, thereby allowing the charge-discharge characteristics to be improved.

As shown in Table 5, Examples 4-4 to 4-34 with the solvent further containing at least one of carbonic acid esters (DEC, EMC) excluding EC, FEC, and DMC included in the first group and chain carboxylic acid esters (PrPr, PrEt, AcPr, AcEt, AcMe) have charge-discharge characteristics further improved as compared with Examples 4-1 to 4-3 with the solvents composed of EC and DMC included in the first group. Accordingly, it is determined that the solvent further contains at least one of carbonic acid esters excluding the compounds included in the first group and chain carboxylic acid esters, thereby allowing the charge-discharge characteristics to be further improved.

As shown in Table 5, Examples 4-4 to 4-29 with the solvent further containing at least one of DEC, EMC, PrPr, PrEt, AcPr, AcEt, and AcMe, have charge-discharge characteristics further improved as compared with Example 4-1 to Example 4-3 with the solvents containing no DEC, EMC, PrPr, PrEt, AcPr, AcEt, or AcMe. Accordingly, it is determined that the solvent further contains at least one of DEC, EMC, PrPr, PrEt, AcPr, AcEt, and AcMe, thereby allowing the charge-discharge characteristics to be further improved.

As shown in Table 5, Examples 4-4 to 4-29 with the solvent further containing at least one of EMC, PrPr, PrEt, AcPr, AcEt, and AcMe have low-temperature load characteristics further improved as compared with Examples 4-1 to 4-3 with the solvents containing no PrPr, PrEt, AcPr, AcEt, or AcMe. Accordingly, it is determined that the solvent further contains at least one of EMC, PrPr, PrEt, AcPr, AcEt, and AcMe, thereby allowing the charge-discharge characteristics to be further improved.

Table 6 is a table showing Example 5-1 to Example 5-13.

TABLE 6

| | | | | First Additive | | Second Additive | |
|---|---|---|---|---|---|---|---|
| | | | | | Content | | Content |
| | Electrolyte | | | | Ratio | | Ratio |
| | Salt (mol/kg) | | Solvent | | (% by | | (% by |
| | LiFSI | LiPF₆ | (mass ratio) | Type | mass) | Type | mass) |
| Example | 2.20 | 0 | EC:PrPr:DMC = 17:66:17 | LiPF₂O₂ | 1.00 | VC | 1.00 |
| 5-1 | | | | | | | |
| Example | 2.20 | 0 | EC:PrPr:DMC = 17:66:17 | LiPF₂O₂ | 1.00 | VEC | 1.00 |
| 5-2 | | | | | | | |
| Example | 2.20 | 0 | EC:PrPr:DMC = 17:66:17 | LiPF₂O₂ | 1.00 | MEC | 1.00 |
| 5-3 | | | | | | | |
| Example | 2.20 | 0 | EC:PrPr:DMC = 17:66:17 | LiPF₂O₂ | 1.00 | FEC | 5.00 |
| 5-4 | | | | | | | |
| Example | 2.20 | 0 | EC:PrPr:DMC = 17:66:17 | LiPF₂O₂ | 1.00 | DFEC | 5.00 |
| 5-5 | | | | | | | |
| Example | 2.20 | 0 | EC:PrPr:DMC = 17:66:17 | LiPF₂O₂ | 1.00 | PS | 1.00 |
| 5-6 | | | | | | | |
| Example | 2.20 | 0 | EC:PrPr:DMC = 17:66:17 | LiPF₂O₂ | 1.00 | PRS | 1.00 |
| 5-7 | | | | | | | |
| Example | 2.20 | 0 | EC:PrPr:DMC = 17:66:17 | LiPF₂O₂ | 1.00 | CD | 1.00 |
| 5-8 | | | | | | | |
| Example | 2.20 | 0 | EC:PrPr:DMC = 17:66:17 | LiPF₂O₂ | 1.00 | SA | 0.50 |
| 5-9 | | | | | | | |
| Example | 2.20 | 0 | EC:PrPr:DMC = 17:66:17 | LiPF₂O₂ | 1.00 | Formula | 0.50 |
| 5-10 | | | | | | (4-2) | |
| Example | 2.20 | 0 | EC:PrPr:DMC = 17:66:17 | LiPF₂O₂ | 1.00 | Formula | 0.50 |
| 5-11 | | | | | | (6-6) | |
| Example | 2.20 | 0 | EC:PrPr:DMC = 17:66:17 | LiPF₂O₂ | 1.00 | SN | 1.00 |
| 5-12 | | | | | | | |
| Example | 2.20 | 0 | EC:PrPr:DMC = 17:66:17 | LiPF₂O₂ | 1.00 | HMI | 1.00 |
| 5-13 | | | | | | | |

| | | Vibration | | | |
|---|---|---|---|---|---|
| | | Spectrum | Test Results | | |
| | | Measurement | | | Low- |
| | | Molar Ratio | | | temperature |
| | Charge- | of Original | Cycle | Storage | Load |
| | discharge | Solvent to | Retention | Retention | Retention |
| | Condition | Li⁺ | Ratio (%) | Ratio (%) | Ratio (%) |
| Example | A | 0.54 | 92 | 88 | 62 |
| 5-1 | | | | | |
| Example | A | 0.54 | 90 | 88 | 64 |
| 5-2 | | | | | |
| Example | A | 0.54 | 90 | 88 | 64 |
| 5-3 | | | | | |
| Example | A | 0.54 | 94 | 87 | 64 |
| 5-4 | | | | | |
| Example | A | 0.54 | 91 | 87 | 63 |
| 5-5 | | | | | |
| Example | A | 0.54 | 90 | 89 | 63 |
| 5-6 | | | | | |
| Example | A | 0.54 | 90 | 89 | 62 |
| 5-7 | | | | | |
| Example | A | 0.54 | 90 | 88 | 64 |
| 5-8 | | | | | |
| Example | A | 0.54 | 90 | 88 | 61 |
| 5-9 | | | | | |
| Example | A | 0.54 | 90 | 90 | 68 |
| 5-10 | | | | | |
| Example | A | 0.54 | 88 | 88 | 65 |
| 5-11 | | | | | |
| Example | A | 0.54 | 89 | 89 | 64 |
| 5-12 | | | | | |
| Example | A | 0.54 | 89 | 88 | 64 |
| 5-13 | | | | | |

### Example 5-1 to Example 5-13

As shown in Table 6, in Example 5-1 to Example 5-13, secondary batteries were prepared, and subjected to the measurement and the tests in the same manner as the battery according to Example 2-15, except that the additives shown in Table 6 were added as a second additive to electrolytic solutions in addition to a lithium difluorophosphate (LiPF₂O₂), which was a lithium fluorophosphate, as a first additive.

As shown in Table 6, Examples 5-1 to 5-13 with the electrolytic solution containing the second additive, which was at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound, have cycle retention ratios and storage retention ratios improved as compared with Example 1-15 containing no second additive. Accordingly, it is determined that the electrolytic solution contains the additive described above, thereby allowing the charge-discharge characteristics to be improved.

Table 7 is a table showing Example 6-1 to Example 6-12.

TABLE 7

| | | | | First | | | |
|---|---|---|---|---|---|---|---|
| | | | | Additive | | Second | |
| | | | | | Content | Additive | |
| | Electrolyte | | | | Ratio | | Content |
| | Salt (mol/kg) | | Solvent | | (% by | | Ratio (% |
| | LiFSI | LiPF₆ | (mass ratio) | Type | mass) | Type | by mass) |
| Example | 2.20 | 0 | EC:PrPr:DMC = 19:24:57 | Formula | 1.00 | VC | 1.00 |
| 6-1 | | | | (4-2) | | | |
| Example | 2.20 | 0 | EC:PrPr:DMC = 19:24:57 | Formula | 1.00 | VEC | 1.00 |
| 6-2 | | | | (4-2) | | | |
| Example | 2.20 | 0 | EC:PrPr:DMC = 19:24:57 | Formula | 1.00 | MEC | 1.00 |
| 6-3 | | | | (4-2) | | | |
| Example | 2.20 | 0 | EC:PrPr:DMC = 19:24:57 | Formula | 1.00 | FEC | 5.00 |
| 6-4 | | | | (4-2) | | | |
| Example | 2.20 | 0 | EC:PrPr:DMC = 19:24:57 | Formula | 1.00 | DFEC | 5.00 |
| 6-5 | | | | (4-2) | | | |
| Example | 2.20 | 0 | EC:PrPr:DMC = 19:24:57 | Formula | 1.00 | PS | 1.00 |
| 6-6 | | | | (4-2) | | | |
| Example | 2.20 | 0 | EC:PrPr:DMC = 19:24:57 | Formula | 1.00 | PRS | 1.00 |
| 6-7 | | | | (4-2) | | | |
| Example | 2.20 | 0 | EC:PrPr:DMC = 19:24:57 | Formula | 1.00 | CD | 1.00 |
| 6-8 | | | | (4-2) | | | |
| Example | 2.20 | 0 | EC:PrPr:DMC = 19:24:57 | Formula | 1.00 | SA | 0.50 |
| 6-9 | | | | (4-2) | | | |
| Example | 2.20 | 0 | EC:PrPr:DMC = 19:24:57 | Formula | 1.00 | LiPF2O2 | 0.50 |
| 6-10 | | | | (4-2) | | | |
| Example | 2.20 | 0 | EC:PrPr:DMC = 19:24:57 | Formula | 1.00 | SN | 1.00 |
| 6-11 | | | | (4-2) | | | |
| Example | 2.20 | 0 | EC:PrPr:DMC = 17:66:17 | LiPF₂O₂ | 1.00 | HMI | 1.00 |
| 6-12 | | | | | | | |

| | | Vibration | | | |
|---|---|---|---|---|---|
| | | Spectrum | Test Results | | |
| | | Measurement | | | Low- |
| | | Molar Ratio | | | temperature |
| | Charge- | of Original | Cycle | Storage | Load |
| | discharge | Solvent to | Retention | Retention | Retention |
| | Condition | Li⁺ | Ratio (%) | Ratio (%) | Ratio (%) |
| Example | A | 0.54 | 94 | 93 | 66 |
| 6-1 | | | | | |
| Example | A | 0.54 | 92 | 93 | 68 |
| 6-2 | | | | | |
| Example | A | 0.54 | 92 | 93 | 68 |
| 6-3 | | | | | |
| Example | A | 0.54 | 96 | 92 | 68 |
| 6-4 | | | | | |
| Example | A | 0.54 | 93 | 92 | 67 |
| 6-5 | | | | | |
| Example | A | 0.54 | 92 | 94 | 67 |
| 6-6 | | | | | |
| Example | A | 0.54 | 92 | 94 | 66 |
| 6-7 | | | | | |
| Example | A | 0.54 | 92 | 93 | 68 |
| 6-8 | | | | | |
| Example | A | 0.54 | 92 | 93 | 65 |
| 6-9 | | | | | |
| Example | A | 0.54 | 92 | 95 | 72 |
| 6-10 | | | | | |
| Example | A | 0.54 | 91 | 94 | 68 |
| 6-11 | | | | | |
| Example | A | 0.54 | 91 | 93 | 68 |
| 6-12 | | | | | |

### Example 6-1 to Example 6-12

As shown in Table 7, in Example 6-1 to Example 6-12, secondary batteries were prepared, and subjected to the measurement and the tests in the same manner as the battery according to Example 2-15, except that the additives shown in Table 7 were added as a second additive to electrolytic solutions in addition to the above-described compound of formula (4-2), which was a sulfinyl compound, as a first additive.

As shown in Table 7, Examples 6-1 to 6-9, Example 6-11, and Example 6-12 with the electrolytic solution containing the second additive, which was at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound, have cycle retention ratios and storage retention ratios improved as compared with Example 2-15 containing no second additive. Accordingly, it is determined that the electrolytic solution contains the additive described above, thereby allowing the charge-discharge characteristics to be improved.

As shown in Table 7, Example 6-10 with the electrolytic solution containing the second additive, which was at least one of a lithium hexafluorophosphate, a lithium tetrafluoroborate, a lithium bis(oxalato) borate, and a lithium difluorophosphate, has a cycle retention ratio and a storage retention ratio improved as compared with Example 2-15 containing no second additive. Accordingly, it is determined that the electrolytic solution contains the additive described above, thereby allowing the charge-discharge characteristics to be improved.

Table 8 is a table showing Example 7-1 to Example 7-12.

TABLE 8

| | | | | | | Second | |
|---|---|---|---|---|---|---|---|
| | | | | First Additive | | Additive | |
| | | | | | Content | | Content |
| | Electrolyte | | | | Ratio | | Ratio |
| | Salt (mol/kg) | | Solvent | | (% by | | (% by |
| | LiFSI | LiPF₆ | (mass ratio) | Type | mass) | Type | mass) |
| Example | 2.20 | 0 | EC:PrPr:DMC = 17:66:17 | SN | 1.00 | VC | 1.00 |
| 7-1 | | | | | | | |
| Example | 2.20 | 0 | EC:PrPr:DMC = 17:66:17 | SN | 1.00 | VEC | 1.00 |
| 7-2 | | | | | | | |
| Example | 2.20 | 0 | EC:PrPr:DMC = 17:66:17 | SN | 1.00 | MEC | 1.00 |
| 7-3 | | | | | | | |
| Example | 2.20 | 0 | EC:PrPr:DMC = 17:66:17 | SN | 1.00 | FEC | 5.00 |
| 7-4 | | | | | | | |
| Example | 2.20 | 0 | EC:PrPr:DMC = 17:66:17 | SN | 1.00 | DFEC | 5.00 |
| 7-5 | | | | | | | |
| Example | 2.20 | 0 | EC:PrPr:DMC = 17:66:17 | SN | 1.00 | PS | 1.00 |
| 7-6 | | | | | | | |
| Example | 2.20 | 0 | EC:PrPr:DMC = 17:66:17 | SN | 1.00 | PRS | 1.00 |
| 7-7 | | | | | | | |
| Example | 2.20 | 0 | EC:PrPr:DMC = 17:66:17 | SN | 1.00 | CD | 1.00 |
| 7-8 | | | | | | | |
| Example | 2.20 | 0 | EC:PrPr:DMC = 17:66:17 | SN | 1.00 | SA | 0.50 |
| 7-9 | | | | | | | |
| Example | 2.20 | 0 | EC:PrPr:DMC = 17:66:17 | SN | 1.00 | Formula | 0.50 |
| 7-10 | | | | | | (4-2) | |
| Example | 2.20 | 0 | EC:PrPr:DMC = 17:66:17 | SN | 1.00 | Formula | 0.50 |
| 7-11 | | | | | | (6-6) | |
| Example | 2.20 | 0 | EC:PrPr:DMC = 17:66:17 | SN | 1.00 | HMI | 1.00 |
| 7-12 | | | | | | | |

| | | Vibration | | | |
|---|---|---|---|---|---|
| | | Spectrum | Test Results | | |
| | | Measurement | | | Low- |
| | | Molar Ratio | | | temperature |
| | Charge- | of Original | Cycle | Storage | Load |
| | discharge | Solvent to | Retention | Retention | Retention |
| | Condition | Li⁺ | Ratio (%) | Ratio (%) | Ratio (%) |
| Example | A | 0.54 | 84 | 87 | 60 |
| 7-1 | | | | | |
| Example | A | 0.54 | 82 | 87 | 62 |
| 7-2 | | | | | |
| Example | A | 0.54 | 82 | 87 | 62 |
| 7-3 | | | | | |
| Example | A | 0.54 | 86 | 86 | 62 |
| 7-4 | | | | | |
| Example | A | 0.54 | 83 | 86 | 61 |
| 7-5 | | | | | |
| Example | A | 0.54 | 82 | 88 | 61 |
| 7-6 | | | | | |
| Example | A | 0.54 | 82 | 88 | 60 |
| 7-7 | | | | | |
| Example | A | 0.54 | 82 | 87 | 62 |
| 7-8 | | | | | |
| Example | A | 0.54 | 82 | 87 | 59 |
| 7-9 | | | | | |
| Example | A | 0.54 | 82 | 89 | 66 |
| 7-10 | | | | | |
| Example | A | 0.54 | 80 | 87 | 63 |
| 7-11 | | | | | |
| Example | A | 0.54 | 81 | 87 | 62 |
| 7-12 | | | | | |

### Example 7-1 to Example 7-12

As shown in Table 8, in Example 7-1 to Example 7-12, secondary batteries were prepared, and subjected to the measurement and the tests in the same manner as the battery according to Example 3-15, except that the additives shown in Table 8 were added as a second additive to electrolytic solutions in addition to the above-described compound of formula (4-2), which was a sulfinyl compound, as a first additive.

As shown in Table 8, Examples 7-1 to 7-12 with the electrolytic solution containing the second additive, which was at least one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound, have cycle retention ratios and storage retention ratios improved as compared with Example 3-15 containing no second additive. Accordingly, it is determined that the electrolytic solution contains the additive described above, thereby allowing the charge-discharge characteristics to be improved.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution,
wherein
the positive electrode includes:
a positive electrode current collector including aluminum; and
a positive electrode active material layer provided on the positive electrode current collector,
the positive electrode active material layer includes a lithium-containing compound,
the electrolytic solution includes an electrolyte, a solvent, and an additive,
the electrolyte includes a lithium bis(fluorosulfonyl)imide salt,
the solvent includes a first solvent including one or more of an ethylene carbonate, a propylene carbonate, a fluoroethylene carbonate, a dimethyl carbonate, and a gamma butyrolactone,
the additive includes a dinitrile compound, 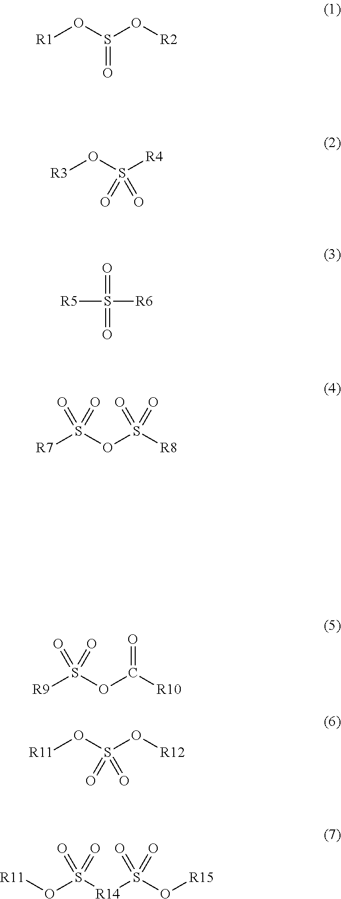
the dinitrile compound includes a compound represented by a formula (8): 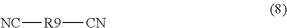
where R9 is any of an alkylene group, a phenylene group, a fluorinated alkylene group, and a fluorinated phenylene group, and
a molar ratio of the original solvent to lithium ions, calculated from a vibration spectrum of the electrolytic solution, is more than 0 and 1.78 or less.

2. The secondary battery according to claim 1, wherein the additive further includes a lithium fluorophosphate,
wherein the lithium fluorophosphate includes at least one of a lithium monofluorophosphate (Li₂PFO₃) and a lithium difluorophosphate (LiPF₂O₂).

3. The secondary battery according to claim 1, wherein the additive further includes a sulfinyl compound,
wherein the sulfinyl compound includes at least one of compounds represented by respective formulas (1), (2), (3), (4), (5), (6), and (7): 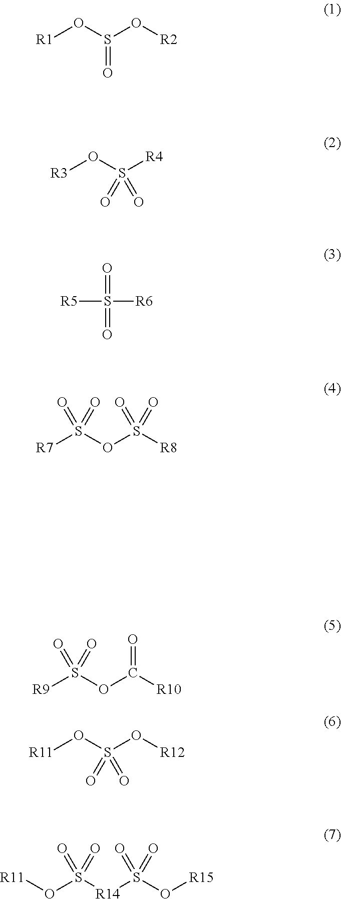
where each of R1 to R15 is any of a monovalent hydrocarbon group and a monovalent fluorinated hydrocarbon group, and R15 is any of a divalent hydrocarbon group and a divalent fluorinated hydrocarbon group, provided that R1 and R2 may be bonded to each other, R3 and R4 may be bonded to each other, R5 and R6 may be bonded to each other, R7 and R8 may be bonded to each other, R9 and R10 may be bonded to each other, R11 and R12 may be bonded to each other, and any two or more of R13 to R15 may be bonded to each other.

4. (canceled)

5. The secondary battery according to claim 1, wherein the solvent includes a second solvent in addition to the first solvent, wherein the second solvent includes one or both of a carbonic acid ester and a chain carboxylic acid esters.

6. The secondary battery according to claim 5, wherein the second solvent includes one or more of a diethyl carbonate, an ethyl methyl carbonate, a propyl propionate, an ethyl propionate, a methyl propionate, a propyl acetate, an ethyl acetate, and a methyl acetate.

7. The secondary battery according to claim 5, wherein the second solvent includes one or more of an ethyl methyl carbonate, a propyl propionate, an ethyl propionate, a propyl acetate, an ethyl acetate, and a methyl acetate.

8. The secondary battery according to claim 1, wherein
the lithium-containing compound includes one of a first lithium composite oxide represented by the formula (9) and a second lithium composite oxide represented by the formula (10): 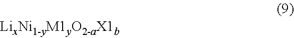
where M1 is one of Co, Mn, Mg, Ba, Al, B, Ti, V, Cr, Fe, Cu, Zn, Zr, Mo, Sn, Ca, Sr, W, Na, K, Nb, Ta, and a rare earth element, X1 is one of F, Cl, Cr, I, P, S, and Si, and x, y, a, and b satisfy 0.9≤x≤1.1, 0.005≤y≤0.5, −0.1≤a≤0.2, and 0≤b≤0.1, 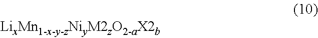
where M2 is one of Co, Mg, Ba, Al, B, Ti, V, Cr, Fe, Cu, Zn, Zr, Mo, Sn, Ca, Sr, W, Na, K, Nb, Ta, and a rare earth element, X2 is one of F, Cl, Cr, I, P, S, and Si, and x, y, z, a, and b satisfy 0<x≤0.3, 0.3≤y≤0.9, 0≤z≤0.5, −0.1≤a≤0.2, and 0≤b≤0.1.

9. The secondary battery according to claim 1, wherein the electrolytic solution includes light metal ions as cations.

10. The secondary battery according to claim 9, wherein the light metal ions include lithium ions.

11. The secondary battery according to claim 10, wherein a content ratio of a lithium bis(fluorosulfonyl)imide in the electrolytic solution is 1.0 mol/kg or more and 3.0 mol/kg or less.

12. The secondary battery according to claim 1, wherein the additive further includes one of an unsaturated cyclic carbonic acid ester, a fluorinated cyclic carbonic acid ester, a sulfonic acid ester, a dicarboxylic acid anhydride, a disulfonic acid anhydride, a sulfuric acid ester, a nitrile compound, and an isocyanate compound.

13. The secondary battery according to claim 1, wherein the electrolytic solution further includes one of a lithium hexafluorophosphate, a lithium tetrafluoroborate, a lithium bis(oxalato) borate, and a lithium difluorophosphate.

14. The secondary battery according to claim 1, wherein the secondary battery is a lithium ion secondary battery.

15. The secondary battery according to claim 1, wherein a content ratio of the dinitrile compound in the electrolytic solution is 0.1% by mass or more and 5% by mass or less.

16. The secondary battery according to claim 1, wherein the molar ratio of the solvent to lithium ions is determined after subjecting the secondary battery to one charge-discharge cycle.

17. The secondary battery according to claim 16, wherein the molar ratio of the solvent to lithium ions is determined after a charge-discharge cycle including charging at 0.2 C under a constant current voltage mode to 4.2 V and followed by discharging at 0.2 C to 2.5 V.
